(19) United States
(12) Patent Application Publication
(10) Pub. No.: US 2009/0034833 A1
(43) Pub. Date: Feb. 5, 2009

(54) EXPOSURE APPARATUS AND EXPOSURE METHOD

(75) Inventors: Yukihisa Ozaki, Kanagawa (JP); Takashi Toyofuku, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: FUJIFILM CORPORATION, Minato-ku, Tokyo (JP)

(21) Appl. No.: 11/922,223

(22) PCT Filed: Jun. 12, 2006
(86) PCT No.: PCT/JP2006/311721

§ 371 Date: Mar. 31, 2008

(30) Foreign Application Priority Data
Jun. 16, 2005 (JP) 2005-176461

(51) Int. Cl. G06K 9/00

(52) U.S. Cl. 382/149

(57) ABSTRACT

Any defect of a board fabricated via a drawing process executed by a drawing device attributed to Gerber data is prevented. Gerber data of vector form representing a wiring pattern drawn directly on a board is loaded before it is expanded into drawing raster data by a RIP processing (100). Thresholds for check are set corresponding to the resolution of the drawing and the type of the photosensitive material on the board (102, 104). Check for presence/absence of any arc portion the circumference length of which is below a threshold th1, presence/absence of any arc portion the radius difference of which is equal to or greater than a threshold th2, presence/absence of any pin-hole region the area of which is equal to or greater than a threshold th5, presence/absence of any pattern the width of the portion overlapping with an adjacent pattern of which is below a threshold th6, and presence/absence of any pattern the gap with adjacent patterns of which is below a threshold th7 is performed (106 to 176). If an error is detected, a Gerber error file for designating an error position is generated and the error position is displayed on a display (182, 184).

### TECHNICAL FIELD

The present invention relates to an image processing device and an image drawing apparatus and system, and more particularly, to an image processing device which is connected to a drawing device for directly drawing a wiring pattern represented by a drawing raster data on a board so as to perform a RIP processing of expanding image data in vector form representing an input wiring pattern into drawing raster data, an image drawing apparatus and an image drawing system including the image processing device.

### BACKGROUND ART

As a drawing method used when a board such as a print wired board (PWB) or a flat panel display (FPD) is produced, conventionally, a method of exposing a wiring pattern to be formed on the board on a film to produce a mask and then drawing the wiring pattern on the board using the mask by area exposure (an analog drawing method) was generally used. Recently, a so-called digital drawing method of directly drawing a wiring pattern on a board on the basis of digital data (drawing raster data) representing a wiring pattern without producing a mask is used (for example, see Japanese Patent Application Laid-Open No. 2004-184921).

In a drawing system using the digital drawing method to perform drawing, a drawing device for drawing on a board and an image processing device connected to the drawing device are provided. The image processing device has a function for inputting image data (data in vector form and with predetermined format representing a wiring pattern to be formed on the board) produced by using computer aided design (CAD)/computer aided manufacturing (CAM), performing a raster image processor (RIP) processing of expanding input image data into drawing raster data, and supplying the drawing raster data obtained by the RIP processing to the drawing device.

### DISCLOSURE OF THE INVENTION

### Problems to be Solved by the Invention

However, since the drawing raster data is data representing the wiring pattern to be formed on the board with the same high resolution as drawing the pattern by the drawing device, the amount of data is significantly large and a time consumed for the RIP processing is relatively long. Therefore, in a case where a problem such as an insufficient gap between adjacent patterns is caused in the wiring pattern when the board is actually produced by drawing the wiring pattern on the board using the drawing raster data obtained by the RIP processing, a subsequent process such as the drawing to the board or the RIP processing requiring a long time needs to be performed after image data is corrected so as to solve the problem. Accordingly, a progress of the operation such as the manufacture of the board is significantly affected and the board is wastefully consumed.

The present invention is conceived in view of the above-described issues and it is an object of the present invention to provide an image processing device, an image drawing apparatus, and an image drawing system, which is capable of preventing a problem from occurring in a board manufactured by a drawing process using a drawing device, due to image data.

### Means for Solving the Problems

In order to accomplish the object, according to a first aspect of the present invention, there is provided an image processing device which is connected with a drawing device that directly draws on a board a wiring pattern represented by drawing raster data, and which performs RIP processing that expands image data in vector form representing the input wiring pattern to the drawing raster data, the apparatus comprising: a checking means which checks whether a defect which causes a problem in the board fabricated by a drawing process using the drawing device is present in the image data, before performing the RIP processing with respect to the input image data.

By this configuration, even when the defect which causes the problem in the board fabricated by the drawing process using the drawing device is present in the input image data, this defect is detected by the checking means before performing the RIP processing with respect to the image data and the RIP processing is performed after the image data is corrected on the basis of the detected defect. Accordingly, it is possible to prevent a problem from occurring in the board due to the image data.

Since the defect of the image data which causes the problem can be detected before performing the RIP processing, the process such as the RIP processing or the drawing by the drawing device does not need to be repeated in vain and thus the progress of the operation such as the fabrication of the board can be prevented from being affected by the defect of the input image data or the board can be prevented from being consumed in vain due to the defect.

Occurrence of the problem due to the image data in the board fabricated by the drawing process using the drawing device depends on the drawing condition applied when the drawing device draws the wiring pattern on the board. Accordingly, in the invention described in the first aspect, it is preferred that, as described in a second aspect, the checking means checks whether the defect is present in the image data, by acquiring a drawing condition applied when the drawing device draws the wiring pattern on the board, setting a threshold which is to be used for determination of the defect in the checking according to the acquired drawing condition, and performing the check using the set threshold.

At a time point when the image data is produced and generated by the CAD/CAM system, the drawing condition when the drawing device draws the wiring pattern on the board is indefinite, therefore it is difficult to efficiently reduce the problem even when it is checked whether or not the defect of the image data is present by this process. In contrast, since the RIP processing expands the image data to the drawing raster data according to the drawing condition (for example, resolution or the like) when the drawing device draws the wiring pattern on the board, the drawing condition is defined at the time point when the RIP processing is performed. In the invention described in a second aspect, since the drawing condition is acquired, thresholds which are to be used in the determination of the defect in the check is set according to the acquired drawing condition and the check is performed using the set thresholds, it is possible to determine whether the defect, which causes the problem due to the image data in the board fabricated by the drawing process using the drawing device, is present in the image data with high precision and to improve the precision of the check using the checking means.

As the drawing condition in the invention described in the second aspect, for example, as described in the third aspect, a resolution applied when the wiring pattern is drawn or the type of a photosensitive material provided on the board may be used.

In the invention described in the second aspect or the third aspect, the checking means may perform, for example, as also described in the fourth aspect, as a process of checking whether or not the defect which causes the problem in the fabricated board is present, at least one of processes of: checking whether or not an arc portion having a circumference length of less than a first threshold is included in the wiring pattern represented by the image data, whether or not an arc portion having a radius difference between a starting point position and an ending point position equal to or greater than a second threshold is included in the wiring pattern, whether or not an arc portion having a radius equal to or greater than a third threshold is included in the wiring pattern, whether or not the wiring pattern is present at a coordinate separated from an original point by a distance equal to or greater than a fourth threshold, whether or not a pin-hole region having an area less than a fifth threshold is present in the wiring pattern represented by the image data, whether or not a pattern in which the width of a region overlapping with an adjacent pattern is less than a sixth threshold is present in the wiring pattern, or whether or not a pattern in which a gap between adjacent patterns is less than a seventh threshold is present in the wiring pattern.

In the invention described in any one of the first aspect to the fourth aspect, the checking means is structured to perform, for example, as also described in the fifth aspect, as a process of checking whether or not the defect which causes the problem in the fabricated board is present, at least one of processes of checking whether or not a line using an aperture shape other than a circle is included in the wiring pattern and checking whether or not a self crossing line, which forms a closed curve having a starting point and an ending point positioned at the same position and which crosses itself between the starting point and the ending point, is included in the wiring pattern.

In the invention described in the first aspect, for example, as described in the sixth aspect, it is preferable that it is checked whether the defect which causes the error in the RIP processing is present in the image data. Accordingly, it can be prevented that the RIP processing stops since the error occurs in the RIP processing due to the image data, and is performed again after correcting the image data. As a process of checking whether or not the defect which causes the error in the RIP processing is present in the image data, for example, as described in the seventh aspect, at least one of processes of: checking whether or not a character other than a character type which can be handled in the RIP processing is included in the image data, whether or not the number of peaks of the wiring pattern is equal to or greater than an eighth threshold, and whether or not the number of layers that form the image data is equal to or greater than a ninth threshold may be performed.

In the invention described in the first aspect, for example, as described in the eighth aspect, the image processing device may further include a data generation means which, if it is determined that the defect is present in the image data by the checking means, acquires a coordinate of the wiring pattern at a position where it is determined that the defect is present, and on the basis of the acquired coordinate, generates defect position designating data designating a predetermined mark at the position in the wiring pattern, the mark being overlappingly displayable on the wiring pattern represented by the image data. By this configuration, when the wiring pattern represented by the image data is displayed on the display means of an information processing apparatus (for example, an information processing apparatus for realizing the CAM system) on the basis of the determination that the defect is present in the image data by the checking means, the predetermined mark can be easily designated (overlappingly displayed) at a position where the defect is present in the displayed wiring pattern by using the defect position designating data generated by the data generation means and the operation for specifying and correcting a portion corresponding to the defect in the image data can be easily performed.

In the invention described in any one of the first aspect to the eighth aspect, for example, as described in the ninth aspect, the image processing device may further include a calculation means which acquires a drawing condition applied when the drawing device draws the wiring pattern on the board and, on the basis of the acquired drawing condition and the image data, calculates a drawing range of the wiring pattern on the board when the drawing device draws the wiring pattern represented by the image data under the current drawing condition; and a positional relationship display control means which displays a positional relationship between the board and the drawing range of the wiring pattern on the board on a display means when the drawing device draws the wiring pattern represented by the image data under the current drawing condition on the basis of the drawing range calculated by the calculation means.

The drawing condition when the drawing device draws the wiring pattern on the board includes information defining the drawing range of the wiring pattern on the board. If the contents of the information are not suitable, the drawing range may be deviated from the board and thus the board may be consumed in vain in the drawing process of the wiring pattern using the drawing device. In contrast, in the invention described in the ninth aspect, since the drawing range of the wiring pattern on the board is calculated on the basis of the drawing condition and the image data and the positional relationship between the board and the drawing range of the wiring pattern on the board is displayed on the display means, it can be checked whether the contents of the information defining the drawing range of the wiring pattern on the board in the drawing condition are suitable, before the drawing device actually draws the wiring pattern on the board. Thus, it is possible to prevent the problem such as unnecessary consumption of the board.

In the invention described in any one of the first aspect to the ninth aspect, for example, as described in the tenth aspect, the image processing device may further include a low-resolution image display control means which generates a low-resolution wiring pattern image representing the wiring pattern in low resolution and displays the generated low-resolution wiring pattern image on a display means, on the basis of the image data; an expansion means which, when an enlarged display target region on the low-resolution wiring pattern image displayed on the display means by the low-resolution display control means, is specified via a specifying means, expands data corresponding to the enlarged display target region in the image data to high-resolution raster data and generates a high-resolution wiring pattern image representing the wiring pattern in the enlarged display target region in high resolution; and a high-resolution image display control means which displays the high-resolution wiring pattern image generated by the expansion means on the display means.

In order to prevent the unnecessary consumption of the board due to a problem in the wiring pattern drawn on the board by the drawing device, it is preferable that it is checked what kind of wiring pattern is to be drawn by the naked eyes, before the drawing device draws the wiring pattern on the board. While, in the conventional analog drawing method, the visible check is performed using a mask fabricated by exposing a wiring pattern in a film, but the mask is not fabricated in the digital drawing method, therefore the visible check is performed by displaying the wiring pattern represented by the drawing raster data on the display means. However, since the drawing raster data has an extremely high resolution as compared with the display means, the wiring pattern that can be displayed on the display means at a time is limited to only a small part of the wiring pattern represented by the drawing raster data. Therefore, in the visible check of the wiring pattern in the digital drawing method, the visible check needs to be repeated while properly scrolling a portion, which will be displayed on the display means, in the wiring pattern represented by the drawing raster data. Accordingly, the operation is troublesome and to which portion of the overall wiring pattern represented by the drawing raster data a portion which is currently displayed on the display means corresponds is hard to be checked. If it is detected that the problem is present in the wiring pattern by the visible check, the RIP processing which is time-consuming needs to be performed again after correcting the image data. Accordingly, the progress of the operation such as the fabrication of the board is affected.

In contrast, in the invention described in the tenth aspect, when the low-resolution wiring pattern image representing the wiring pattern in low resolution is generated and displayed on the display means and the enlarged display target region is specified via the specifying means on the low-resolution wiring pattern image displayed on the display means, the data corresponding to the enlarged display target region in the image data is expanded to the high-resolution raster data, the high-resolution wiring pattern image representing the wiring pattern in the enlarged display target region in high resolution is generated and displayed on the display means. Accordingly, by specifying the enlarged display target region via the specifying means on the low-resolution wiring pattern image, it is possible to perform the visible check with respect to a desired portion of the wiring pattern represented by the image data, to simplify the operation, and easily check the position of the portion displayed as the high-resolution wiring pattern image on the overall wiring pattern. Since the data corresponding to the specified enlarged display target region in the image data is expanded to the high-resolution rater data (high-resolution wiring pattern image) and is displayed on the display means, the RIP processing does not need to be performed before displaying the high-resolution wiring pattern image. Even when it is detected that the problem is present in the wiring pattern by the visible check, the RIP processing which is time-consuming does not need to be performed multiple times. Accordingly, the progress of the operation such as the fabrication of the board is prevented from being affected.

In the invention described in the tenth aspect, when the wiring pattern drawn on the board by the drawing device is configured by arranging a plurality of sheets formed from plurally arranged identical unit wiring patterns that correspond to a single circuit pattern, for example, as described in the eleventh aspect, the low-resolution image display control means generates and displays an image representing the overall wiring pattern in low resolution as the low-resolution wiring pattern image, and when a specific sheet is specified as the enlarged display target region on the low-resolution wiring pattern image representing the overall wiring pattern, the expansion means only expands data corresponding to a single specific unit wiring pattern in the specific sheet of the image data to high-resolution raster data, and generates an image as a high-resolution wiring pattern image of the specific sheet, wherein the wiring pattern is displayed with respect to only the specific unit wiring pattern, while only a framing line representing an outer edge is displayed with respect to other unit wiring patterns.

If the wiring pattern (overall wiring pattern) drawn on the board by the drawing device is the wiring pattern in which a plurality of sheets configured by plurally arranging the identical unit wiring pattern corresponding to a single circuit pattern are arranged, the visible check is performed with respect to only one of the unit wiring patterns in the overall wiring pattern. Accordingly, in the eleventh aspect of the invention, if a specific sheet in which the identical unit wiring pattern is plurally arranged is specified as an enlarged display target region, since a high-resolution wiring pattern image of the specific sheet is generated wherein only a specific unit wiring pattern is displayed and only a framing line representing an outer edge is displayed with respect to other unit wiring patterns, it is possible to generate and display the high-resolution wiring pattern image of the specific sheet specified as the enlarged display target region for a short time.

In the invention described in the tenth aspect, for example, as described in the twelfth aspect, the image processing device may further include a distance calculation and display means which, when two points of a target for distance measuring are specified via the specifying means on the high-resolution wiring pattern image displayed on the display means by the high-resolution image display control means, calculates and displays on the display means a distance between the specified two points.

In the digital drawing method, since the wiring pattern representing the drawing raster data is drawn on the board with predetermined resolution, the positions of portions of the wiring pattern which is actually drawn on the board or the wiring pattern represented by the drawing raster data changes the distance between adjacent pixels in the resolution of the drawing as a maximum with respect to the wiring pattern represented by the image data due to the influence of a rounding error. Accordingly, it is preferable that it is finally checked whether the pin-hole region of which the area is less than the fifth threshold is present in the wiring pattern, whether the pattern in which the width of the region overlapping with the adjacent pattern is less than the sixth threshold is present in the wiring pattern, or whether the pattern of which the gap between the adjacent patterns is less than the seventh threshold is presented in the wiring pattern, on the wiring pattern represented by the high-resolution raster data obtained by expanding the image data.

In the invention described in the twelfth aspect, when the two points for measuring the distance is specified on the high-resolution wiring pattern image, since the distance between the specified two points is calculated and displayed on the display means, in the visible check of the wiring pattern based on the high-resolution wiring pattern image, it is possible to accurately and easily check the presence/absence of the pin-hole region of which the area is less than the fifth threshold, the presence/absence of the pattern in which the width of the region overlapping with the adjacent pattern is less than the sixth threshold, and the presence/absence of the pattern of which the gap between the adjacent patterns is less than the seventh threshold, and to realize laborsaving of the visible check.

According to a thirteenth aspect of the invention, there is provided an image drawing apparatus including: the image processing device according to any one of the first aspect to the twelfth aspect, wherein drawing on a drawing surface is performed on the basis of the drawing raster data obtained by the image processing device. Similar to the first aspect of the invention, it is possible to prevent a problem from occurring in the board fabricated by the drawing process using the drawing device, due to the image data.

According to a fourteenth aspect of the invention, there is provided an image drawing system including: at least one of a computer aided design (CAD) system or a computer aided Manufacturing (CAM) system which generates the image data in vector form; the image processing device according to any one of claims 1 to 13; and an drawing device which performs drawing on a drawing surface on the basis of the drawing raster data obtained by the image processing device. By this configuration, it is possible to prevent a problem from occurring in the board fabricated by the drawing process using the drawing device, due to the image data.

### EFFECT OF THE INVENTION

As described above, according to the present invention, since it is checked whether a defect which causes a problem in a board fabricated by a drawing process using a drawing device is present in image data before performing RIP processing with respect to the image data in vector form representing a wiring pattern, it is possible to prevent a problem from occurring in the board fabricated by the drawing process using the drawing device, due to the image data.

### BRIEF DESCRIPTION OF THE DRAWINGS

FIG. 1 is a schematic view showing the configuration of a board drawing system according to the present embodiment.

FIG. 2 is a functional block diagram showing the flow of data in an image processing device.

FIG. 3 is a flowchart illustrating contents of a data check process.

FIG. 4A is an image view illustrating the check of shift between a starting/ending point and a central point of an arc portion.

FIG. 4B is an image view illustrating the check of an aperture shape.

FIG. 4C is an image view illustrating the check of a self-crossing line.

FIG. 4D is an image view illustrating the structure (layer) of Gerber data.

FIG. 5A is an image view illustrating the check of a pattern, in which an overlap is insufficient in a data check process.

FIG. 5B is an image view illustrating the check of a pattern, in which an overlap is insufficient in a data check process.

FIG. 6 is an image view showing an example of a Gerber error file.

FIG. 7 is an image view showing an example of an error position display.

FIG. 8 is a flowchart illustrating contents of a layout checking process.

FIG. 9 is an image view showing an example of a layout display screen.

FIG. 10A is an image view showing 90° rotation of a wiring pattern on the layout display screen.

FIG. 10B is an image view showing 180° rotation of the wiring pattern on the layout display screen.

FIG. 11A is an image view showing an X-direction mirror display of a wiring pattern on the layout display screen.

FIG. 11B is an image view showing a Y-direction mirror display of the wiring pattern on the layout display screen.

FIG. 12 is a flowchart illustrating contents of a raster display process.

FIG. 13 is an image view showing an example of arrangement of pieces in a drawing unit (the overall wiring pattern).

FIG. 14 is an image view showing an example of a raster display screen.

FIG. 15 is an image view showing a state in which pieces are displayed on the raster display screen.

FIG. 16 is an image view showing a state in which a sheet is displayed on the raster display screen.

FIG. 17 is an image view showing a state in which a distance between two specified points is displayed in a raster display of a wiring pattern.

### BEST MODE FOR CARRYING OUT THE INVENTION

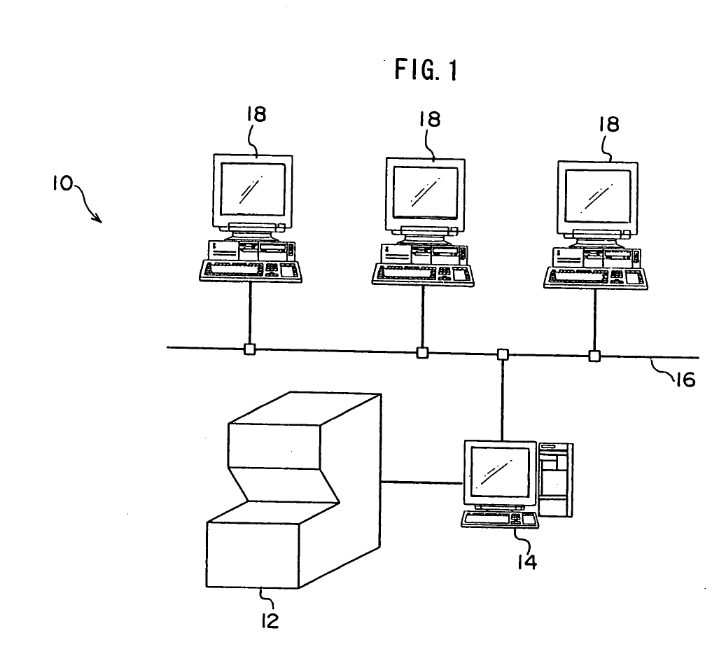

Hereinafter, embodiments of the present invention will be described in detail with reference to the accompanying drawings. FIG. 1 shows a board drawing system 10 according to the present invention. The board drawing system 10 corresponds to an image drawing system according to a fourteenth aspect of the present invention and includes an exposure device 12 as a drawing device for directly drawing a wiring pattern represented by input drawing raster data on a board having a photosensitive material coated on the surface thereof. As the exposure device 12, for example a configuration for irradiating a light beam modulated according to drawing raster data onto a board using a spatial light modulator such as a digital micro-mirror device (DMD) to draw a wiring pattern on the board may be used. The board on which the wiring pattern is drawn by the exposure device 12 is subjected to known processes such as expansion, etching, cleaning, cut, punching processes so as to be formed as a printed wiring board (PWB) on which the wiring pattern is formed and a circuit element can be mounted.

The exposure device 12 is connected with an image processing device 14 for supplying the drawing raster data to the exposure device 12. The image processing unit 14 is connected to a plurality of computers 18, which function as a CAD/CAM system, via a network 16 such as a local area network (LAN). Although three computers 18 are, for example, shown in FIG. 1, the number of computers 18 is not limited to this example. In (the computer 18 functioning as) the CAD system, a process of designing an electronic circuit mounted on a printed wiring board or designing a wiring pattern to be formed on the printed wiring board (a wiring pattern corresponding to the below-described piece (a unit wiring pattern)) is performed and data with predetermined format representing the wiring pattern is output to another computer 18 (or the same computer) functioning as the CAM system via the network 16.

When the data representing the wiring pattern is input, (the computer 18 functioning as) the CAM system performs an editing process of determining how the wiring pattern represented by the input data is arranged at the time of drawing (layout), determining at which position of the board a punching process is performed, or adding a comment to be drawn together with the wiring pattern. In addition, image data (hereinafter, referred to as Gerber data) representing the overall wiring pattern to be drawn on the board by one drawing process in vector form (data form representing an image as a set of a parameter such as an equation of coordinates of points such as a starting point or an ending point and a line or a surface connecting the points, and drawing information such as painting or special effects) is generated and the Gerber data is transmitted to the image processing device 14 via the network 16. The punching positions in the board determined in the editing process is output to a drill device (not shown) for punching the board as drill hole data.

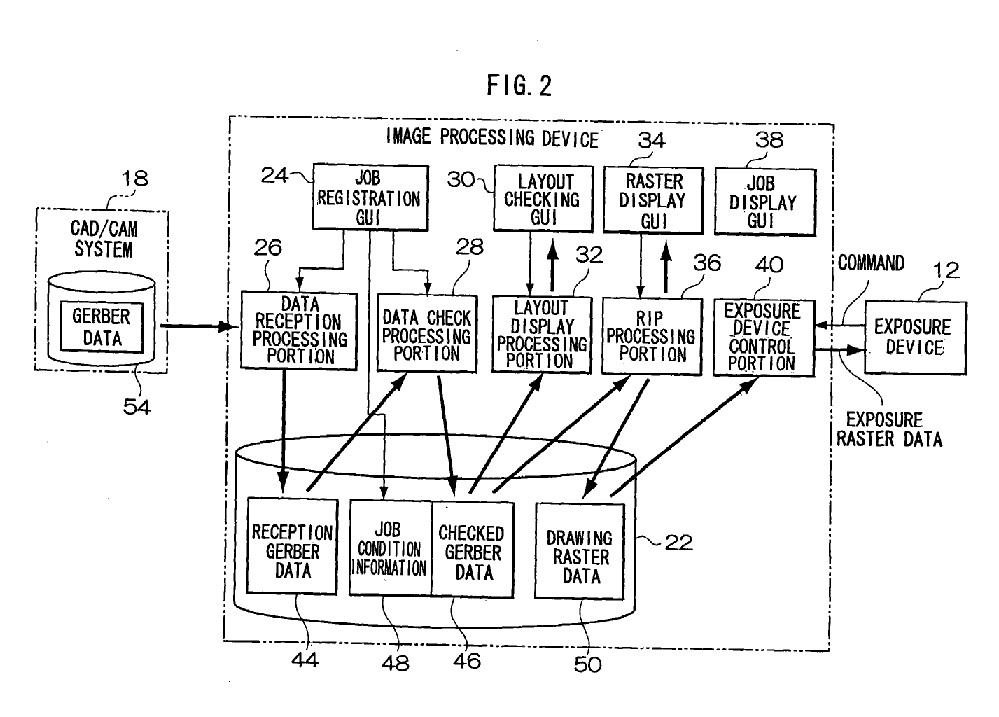

Meanwhile, the image processing device 14 corresponds to the image processing device according to the present invention and is configured by a personal computer (PC), which includes a central processing unit (CPU), a memory, a HDD 22 (see FIG. 2), a display as display means, a keyboard, and a mouse. In the HDD of the image processing device 14, a variety of application programs for allowing the CPU of the image processing device 14 to function as a job registration graphical user interface (GUI) 24, a data reception processing portion 26, a data check processing portion 28, a layout checking GUI 30, a layout display processing portion 32, a raster display GUI 34, a RIP processing portion 36, a job display GUI 38 and an exposure device control portion 40 shown in FIG. 2 are installed. In the HDD 22, a reception Gerber data folder 44 for storing the Gerber data acquired from the CAM system, a checked Gerber data folder 46 for storing Gerber data subjected to a data check process (described later in detail) by the data check processing portion 28, a job condition information folder 48 for storing job condition information input via the job registration GUI 24, and a drawing raster data folder 50 for storing drawing raster data obtained by RIP processing of the RIP processing portion 36 are provided. The image processing device 14 according to the present embodiment can be connected with two exposure devices 12 as a maximum. The exposure device 12 and the image processing device 14 also correspond to an image drawing apparatus according to a thirteenth aspect of the present invention.

Next, as the operation of the present embodiment, a series of processes performed by the image processing device 14 in order to obtain the drawing raster data from the Gerber data will be sequentially described.

In the present embodiment, the Gerber data generated by the CAM system is recorded/stored in a recording medium 54 (for example, a specific folder which is provided in the HDD included in the computer 18 functioning as the CAM system and is set to be accessed by the image processing device 14) which can be accessed by the image processing device 14 via the network. In a screen which can be displayed by the job registration GUI 24 on a display of the image processing device 14, a data acquisition instructing screen for instructing the acquisition of the Gerber data from the recording medium 54 is included. When a user manipulates the keyboard or the mouse to instruct the acquisition of specific Gerber data from the recording medium 54 in a state in which the data acquisition instructing screen is displayed on the display, this instruction is input to the data reception processing portion 26 via the job registration GUI 24 and the data reception processing portion 26 reads and acquires the instructed specific Gerber data from the recording medium 54 via the network 16 and stores the acquired Gerber data in the reception Gerber data folder 44.

The CAD/CAM system which can be realized by the computer 18 includes systems having various specifications/functions. When the Gerber data is acquired from the recording medium 54, the data reception processing portion 26 checks the format of the acquired Gerber data, performs a process of converting the Gerber data to Gerber data having a predetermined format as necessary, and stores the converted Gerber data in the reception Gerber data folder 44.

In the screen which can be displayed by the job registration GUI 24 on the display of the image processing device 14, a check instructing screen for instructing the check of the Gerber data stored in the reception Gerber data folder 44 is included. Although not shown, in the check instructing screen, a display section for displaying a list of file names of the Gerber data stored in the reception Gerber data folder 44, an input section for inputting a job condition such as the number of boards, on which the wiring pattern is drawn, or a drawing condition (for example, resolution, the type of the exposure device 12 used for the drawing of the wiring pattern, a drawing mode, the size of the board on which the wiring pattern is drawn, the presence/absence of the rotation or reverse (mirror) of the wiring pattern represented by the Gerber data or the direction of the rotation angle or the reverse (mirror), the type of the photosensitive material coated on the board or the like) at the time of drawing of the wiring pattern with respect to the Gerber data selected from the list of the Gerber data displayed in the display section as an object to be processed, and a button for instructing execution of the data check process with respect to the Gerber data selected from the list of the Gerber data displayed in the display section as the object to be processed are provided.

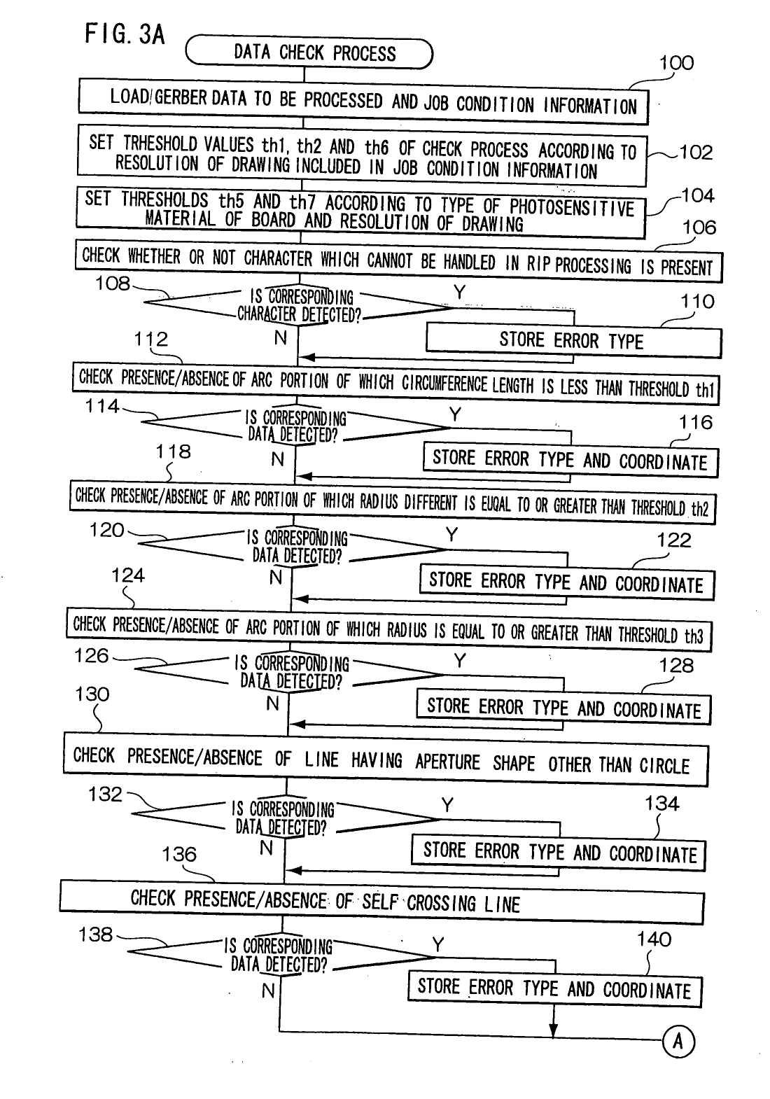

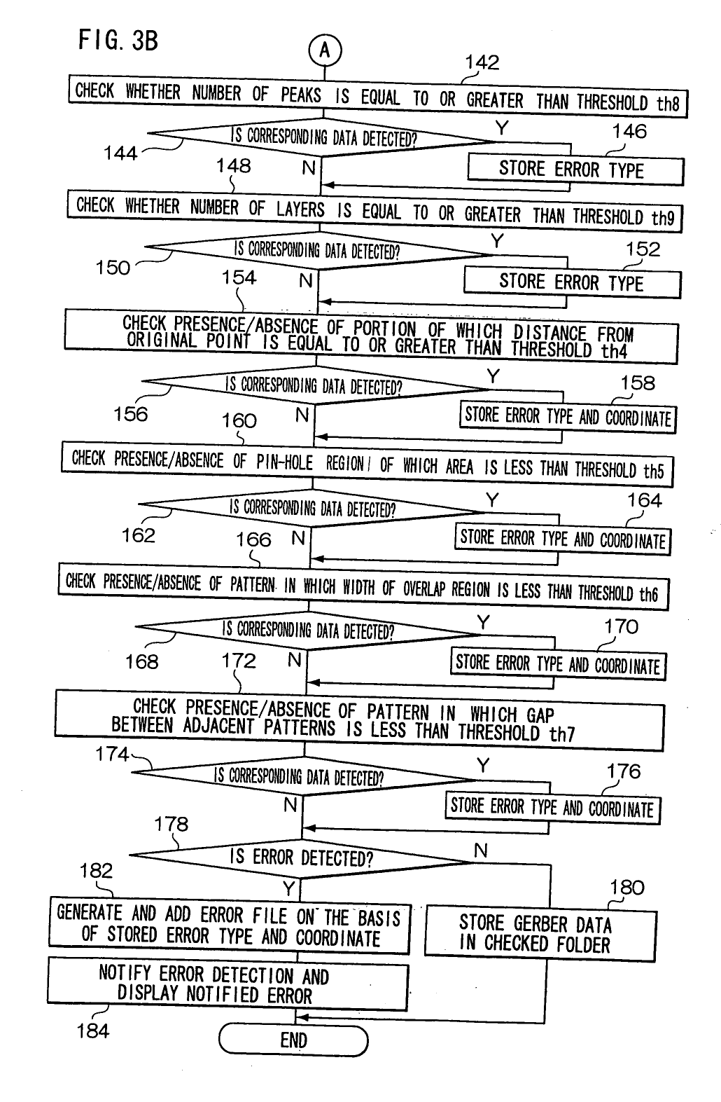

When the user selects Gerber data as an object to be processed from the list of the Gerber data displayed in the display section in the check instructing screen via the keyboard or the mouse in a state in which the check instructing screen is displayed on the display and performs an operation for inputting the job condition of the Gerber data as the object to be processed in the input section in the check instructing screen, the job condition information indicating the input job condition is stored in the job condition information folder 48 as the job condition of the Gerber data as the object to be processed. When the button of the check instructing screen is selected to instruct the execution of the data check process with respect to the Gerber data as the object to be processed, this instruction is input to the data check processing portion 28 via the job registration GUI 24 and data check process shown in FIG. 3 is performed by the data check processing portion 28. This data check process corresponds to the process of the check means according to the present invention and the data check processing portion 28 for executing the data check process corresponds to the check means according to the present invention.

This data check process checks whether or not a defect which causes an error in the RIP processing using the RIP processing portion 36 is present or a defect which causes a problem in a printed wiring board fabricated by drawing the wiring pattern on the board using the exposure device 12 is present, with respect to the Gerber data as the object to be processed. First, in a step 100, the Gerber data as the object to be processed is loaded from the checked Gerber data folder 46 and the job condition information corresponding to this Gerber data is loaded from the job condition information folder 48.

In a step 102, thresholds th1, th2 and th6 which are to be used in the below-described processing are set according to the resolution of the drawing included in the job condition information loaded in the step 100. Although described later in detail, the threshold th1 is a threshold of a circumferential length used when it is checked whether or not a minute arc portion having a extremely small (for example, about several μm) circumference length is present, the threshold th2 is a threshold of a radius difference used when it is checked whether or not an arc portion having a radius difference between the starting point and the ending point is present, and the threshold th6 is a threshold of a width used when it is checked whether or not a pattern having a small overlapping width (overlap region) with an adjacent pattern is present. In the step 102, the thresholds th1, th2 and th6 are set such that the thresholds th1, th2 and th6 are decreased as the resolution of the drawing is increased (that is, an interval between pixels in the wiring pattern drawn on the board by the exposure device 12 is decreased).

In a step 104, thresholds th5 and th7 which are to be used in the below-described process are set according to the type of the photosensitive material coated on the board and the resolution of the drawing included in the job condition information loaded in the step 100. Although described later in detail, the threshold th5 is a threshold of an area used when it is checked whether or not a pin-hole region having a minute area is present and the threshold th7 is a threshold of a gap used when it is checked whether or not a pattern having a small gap between adjacent patterns is present. In the drawing of the wiring pattern on the board by the exposure device 12, clearness of a boundary (edge portion) of an exposure portion and a non-exposure portion in the wiring pattern drawn on the board depends on the magnitude of the tilt of exposure amount and concentration characteristics of the photosensitive material coated on the board, and the position of the edge portion in the wiring pattern formed on the board via an etching process is shifted by a shift amount according to the smallness of the clearness of the edge portion in a direction in which the area of the portion removed by the etching process between the exposure portion and the non-exposure portion is increased. In addition, by the shift of the position of the edge portion, the gap between adjacent patterns or the area of the pin-hole region varies.

The varying direction of the gap between adjacent patterns or the area of the pin-hole region according to the variation in clearness of the edge portion varies depending on whether the exposure portion in the drawing of the wiring pattern becomes a remaining side (pattern portion) or a removed side (gap portion) in the etching process, which can be determined from the type (a negative type or a positive type) of the photosensitive material. In addition, the magnitude of the tilt of the exposure amount and concentration characteristics of the photosensitive material can be determined from the type of the photosensitive material. In the present embodiment, when the wiring pattern is drawn in various types of photosensitive materials to fabricate the printed wiring board, it is measured how much the actual position of the edge portion is shifted from an original position and the measured result is stored in the HDD as a table. In the step 104, after the thresholds th5 and th7 are set according to the resolution of the drawing, the shift amount of the edge portion corresponding to the type of the photosensitive material coated on the board is acquired with reference to the table and the thresholds th5 and th7 are corrected according to the acquired shift amount such that the thresholds th5 and th7 according to the type of the photosensitive material and the resolution of the drawing are set.

Meanwhile, although, in the above-described RIP processing portion 36, the RIP processing of expanding the Gerber data (in more detail, the Gerber data stored in the checked Gerber data folder 46) to the drawing raster data in raster format (bitmap format) is performed, however handleable character types are restricted in the RIP processing, therefore, when the character other than the handleable character types (a half-width kana character or the like) is included in the Gerber data which is subjected to the RIP processing, an error is caused and the RIP processing is stopped when this kind of character is detected. Accordingly, in the next step 106, it is checked whether or not the character other than the character types which can be handled by the RIP processing is included by sequentially referring to the Gerber data as the object to be processed. When the check process of the step 106 is completed, the process progresses to a step 108, in which it is determined whether the corresponding character is detected in the check process of the step 106. If the determination is “no”, the process progresses to a step 112 and, if the determination is “yes”, the process progresses to a step 110, which stores error type information indicating that the detected error (defect) is an error that the character other than the character types which can be handled by the RIP processing is included in the Gerber data as the object to be processed, in the memory and then the process progresses to the step 112.

In a case where the minute arc portion having the extremely small circumference length (for example, about several μm) is included in the wiring pattern, since the minute arc portion causes a problem of the printed wiring board fabricated by the drawing process using the exposure device 12, the minute arc portion is preferably converted to a straight line. Accordingly, in the next step 112, a process of checking whether or not data defining the minute arc portion of which the circumference length is less than the threshold th1 is included in the Gerber data as the object to be processed is performed. Since the threshold th1 is set according to the resolution of the drawing in the above-described step 102, it can be checked whether or not the minute arc portion which causes the problem of the printed wiring board is included in the wiring pattern with high precision. When the check process of the step 112 is completed, the process progresses to a step 114, in which it is determined whether the corresponding data is detected in the check process of the step 112. If the determination is “no”, the process progresses to a step 118 and, if the determination is “yes”, the process progresses to a step 116, which stores the error type information indicating that the detected error (defect) is an error that the data defining the minute arc portion is included in the Gerber data as the object to be processed, and coordinate information indicating the position of the minute arc portion on the wiring pattern represented by the Gerber data in the memory, and then progresses to the step 118.

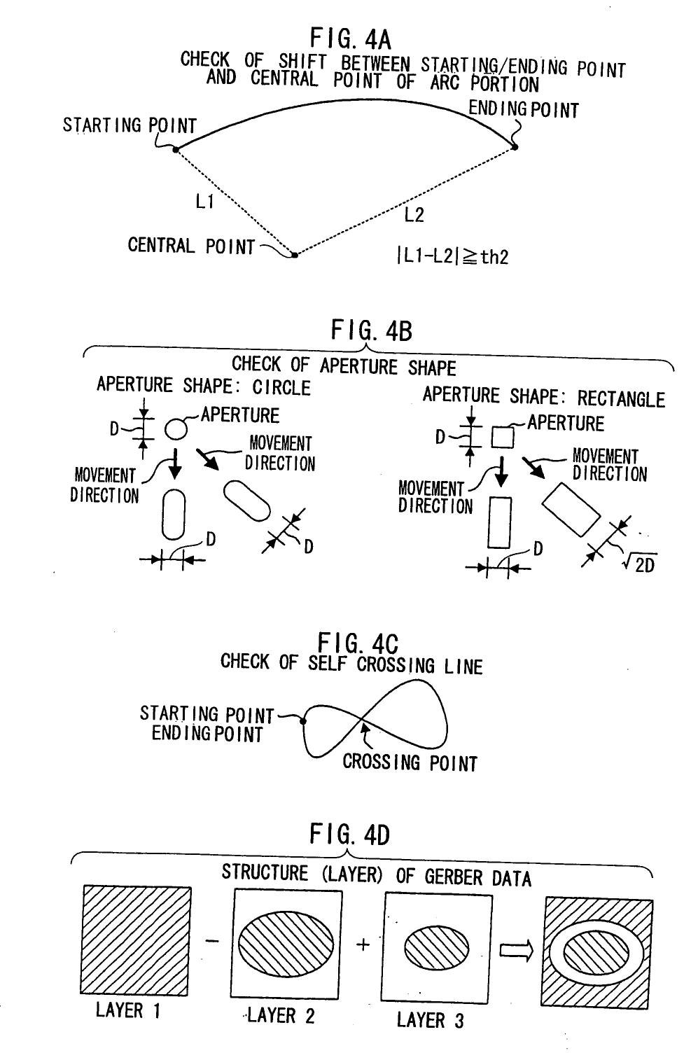

For example, as shown in FIG. 4A, if an arc portion of which a difference |L1−L2| between the radius L1 of the starting point and the radius L2 of the ending point is equal to or greater than a predetermined value (for example, about several tens of μm) is included in the wiring pattern, this arc portion may cause a problem of the printed wiring board fabricated by the drawing process using the exposure device 12 and is not preferable. Accordingly, in the next step 118, a process of checking whether or not data defining the arc portion of which the radius difference |L1−L2| is equal to or greater than the threshold th2 is included in the Gerber data as the object to be processed is performed. Since the threshold th2 is also set according to the resolution of the drawing in the above-described step 102, it can be checked whether or not the arc portion having the radius difference, which causes the problem of the printed wiring board, is included, with high precision. When the check process of the step 118 is completed, the process progresses to a step 120, in which it is determined whether the corresponding data is detected in the check process of the step 118. If the determination is “no”, the process progresses to a step 124 and, if the determination is “yes”, the process progresses to a step 122, which stores the error type information indicating that the detected error (defect) is an error that the data defining the arc portion having the radius difference is included in the Gerber data as the object to be processed, and coordinate information indicating the position of the arc portion having the radius difference on the wiring pattern represented by the Gerber data in the memory, and then progresses to the step 124.

In addition, since an arc portion having a significantly large radius (for example, about one thousand hundreds mm) is not generally used in the wiring pattern, if the arc portion having the significantly large radius is included in the wiring pattern, this arc portion may cause a problem of the printed wiring board fabricated by the drawing process using the exposure device 12. Accordingly, in the next step 124, a process of checking whether or not data defining the arc portion of which the radius is equal to or greater than the threshold th3 is included in the Gerber data as the object to be processed is performed. When the check process of the step 124 is completed, the process progresses to a step 126, in which it is determined whether the corresponding data is detected in the check process of the step 124. If the determination is “no”, the process progresses to a step 130 and, if the determination is “yes”, the process progresses to a step 128, which stores the error type information indicating that the detected error (defect) is an error that the data defining the arc portion having the significantly large radius is included in the Gerber data as the object to be processed, and coordinate information indicating the position of the arc portion having the significantly large radius on the wiring pattern represented by the Gerber data in the memory, and then progresses to the step 130.

For example, as shown in FIG. 4B, although the Gerber data specifies the shape of an aperture, the position of the starting point and the ending point such that a trace obtained by moving the aperture having the specified shape from the starting point to the ending point is drawn as a line, if the shape of the aperture is a circle, the width of the line is constant (=the diameter of the circle) regardless of the movement direction of the aperture, but if the shape of the aperture is not the circle, the width of the line varies according to the movement direction of the aperture. Accordingly, if the line drawn using the aperture having the shape other than the circle is included in the wiring pattern, this line may cause a problem of the printed wiring board fabricated by the drawing process using the exposure device 12. Accordingly, in a step 130, a process of checking whether or not data drawing the line using the aperture having the shape other than the circle is included in the Gerber data as the object to be processed is performed. When the check process of the step 130 is completed, the process progresses to a step 132, in which it is determined whether the corresponding data is detected in the check process of the step 130. If the determination is “no”, the process progresses to a step 136 and, if the determination is “yes”, the process progresses to a step 134, which stores the error type information indicating that the detected error (defect) is an error that the data drawing the line using the aperture having the shape other than the circle is included in the Gerber data as the object to be processed, and coordinate information indicating the position of the line drawn using the aperture having the shape other than the circle on the wiring pattern represented by the Gerber data in the memory, and then progresses to the step 136.

For example, as shown in FIG. 4C, although a self crossing line which has a starting point and an ending point positioned at the same position (a closed curve is formed) and crosses itself between the starting point and the ending point is not generally used in the wiring pattern, if the self crossing line is included in the wiring pattern, a problem of the printed wiring board fabricated by the drawing process using the exposure device 12 may be caused. Accordingly, in the step 136, a process of checking whether or not data defining the self crossing line is included in the Gerber data as the object to be processed is performed. When the check process of the step 136 is completed, the process progresses to a step 138, in which it is determined whether the corresponding data is detected in the check process of the step 136. If the determination is “no”, the process progresses to a step 142 and, if the determination is “yes”, the process progresses to a step 140, which stores the error type information indicating that the detected error (defect) is an error that the data defining the self crossing line is included in the Gerber data as the object to be processed, and coordinate information indicating the position of the self crossing line on the wiring pattern represented by the Gerber data in the memory, and then progresses to the step 142.

In addition, in the RIP processing, there is an upper limit (for example, 2048) in the number of peaks included in the Gerber data which is subjected to the RIP processing, when the peaks whose number exceeds the upper limit are included in the Gerber data which is subjected to the RIP processing, an error may be caused in the step of detecting the number of the peaks which exceeds the upper limit and thus the RIP processing is stopped. Accordingly, in the step 142, a process of checking whether the number of peaks included in the Gerber data as the object to be processed is equal to or greater than the threshold th8 (=the upper limit in the RIP processing) is performed. When the check process of the step 142 is completed, the process progresses to a step 144, in which it is determined whether the number of peaks is equal to or greater than the threshold th8 in the check process of the step 142. If the determination is “no”, the process progresses to a step 148 and, if the determination is “yes”, the process progresses to a step 146, which stores the error type information indicating that the detected error (defect) is an error that the peaks whose number exceeds the upper limit is included in the Gerber data as the object to be processed in the memory, and then progresses to the step 148.

For example, as shown in FIG. 4D, although the Gerber data is data indicating an objective image (wiring pattern) by dividing the objective image (wiring pattern) into images of a plurality of layers and adding data for instructing the addition or the subtraction of the images of the layers, in the RIP processing, there is an upper limit (for example, 1024) in the number of layers configuring the Gerber data which is subjected to the RIP processing, therefore when the Gerber data which is subjected to the RIP processing is configured by the layers whose number exceeds the upper limit, an error may be caused in the step of detecting the number of the layers exceeding the upper limit and thus the RIP processing is stopped. Accordingly, in a step 148, a process of checking whether the number of the layers configuring the Gerber data as the object to be processed is equal to or greater than the threshold th9 (=the upper limit in the RIP processing) is performed. When the check process of the step 148 is completed, the process progresses to a step 150, in which it is determined whether the number of the layers is equal to or greater than the threshold th9 in the check process of the step 148. If the determination is “no”, the process progresses to a step 154 and, if the determination is “yes”, the process progresses to a step 152, which stores the error type information indicating that the detected error (defect) is an error that the number of the layers configuring the Gerber data as the object to be processed exceeds the upper limit in the memory, and then progresses to the step 154.

In addition, when a portion of which the distance from the original point of the Gerber data is significantly large (for example, about one thousand hundreds mm) is included in the wiring pattern, the drawing position of the portion of which the distance from the original point is significantly large is deviated from the board in the drawing process using the exposure device 12, therefore a possibility that a proper printed wiring board is not fabricated is high. Accordingly, in the step 154, a process of checking whether or not the portion of which the distance from the original point of the Gerber data is equal to or greater than the threshold th4 is included in the wiring pattern represented by the Gerber data as the object to be processed is performed. When the check process of the step 154 is completed, the process progresses to a step 156, in which it is determined whether the corresponding data is detected in the check process of the step 154. If the determination is “no”, the process progresses to a step 160 and, if the determination is “yes”, the process progresses to a step 158, which stores the error type information indicating that the detected error (defect) is an error that the portion of which the distance from the original point of the Gerber data is significantly large is included in the wiring pattern represented by the Gerber data as the object to be processed, and coordinate information indicating the position of the portion, of which the distance from the original point is significantly large, on the wiring pattern represented by the Gerber data in the memory, and then progresses to the step 160.

In addition, although a pin-hole region having a minute area is not generally used in the wiring pattern, in a case where the pin-hole region having the minute area is included in the wiring pattern, a problem may be caused in the printed wiring board fabricated by the drawing process using the exposure device 12. Accordingly, in the step 160, a process of checking whether or not data defining the pin-hole region of which the area is less than the threshold th5 is included in the Gerber data as the object to be processed is performed. Since the threshold th5 is set according to the type of the photosensitive material coated on the board and the resolution of the drawing in the above-described step 104, it can be checked whether or not the pin-hole region having the minute area, which causes the problem of the printed wiring board, is included in the wiring pattern, with high precision. When the check process of the step 160 is completed, the process progresses to a step 162, in which it is determined whether the corresponding data is detected in the check process of the step 160. If the determination is “no”, the process progresses to a step 166 and, if the determination is “yes”, the process progresses to a step 164, which stores the error type information indicating that the detected error (defect) is an error that the data defining the pin-hole region having the minute area is included in the Gerber data as the object to be processed, and coordinate information indicating the position of the pin-hole region having the minute area on the wiring pattern represented by the Gerber data in the memory, and then progresses to the step 166.

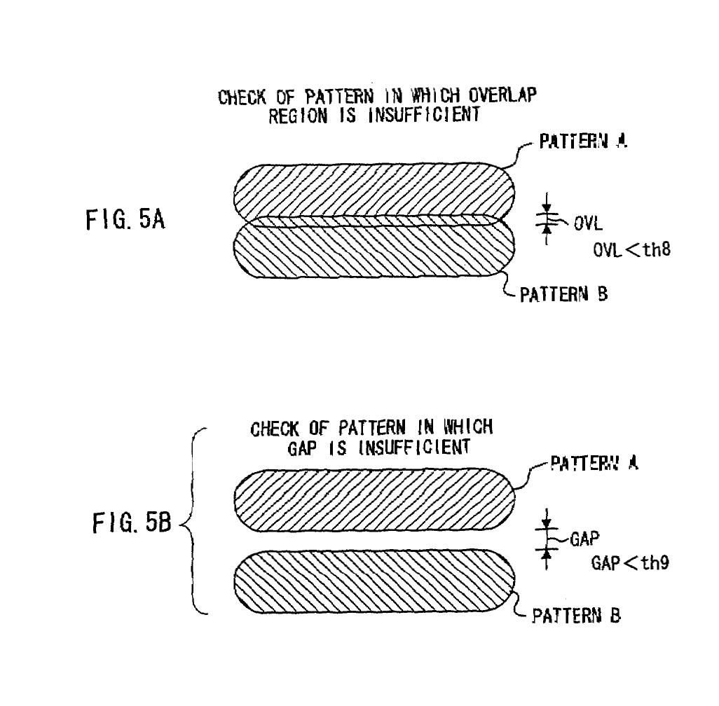

In the Gerber data, in a case any region of the objective image (wiring pattern) is painted, instead of using a command for instructing painting, for example, as shown in FIG. 5A, data for instructing the painting in a desired region by instructing the drawing of a plurality of lines such that portions of the adjacent lines overlap each other (an overlapped portion is called an overlap region) may be set. At this time, if the width OVL of the overlap region is insufficient, a portion corresponding to the overlap region in the wiring pattern on the printed wiring board fabricated by the drawing process using the exposure device 12 may becomes the same state as a portion which is drawn in the drawing process.

Accordingly, in the step 166, a process of checking whether or not data defining a pattern (a line or the like) in which the width of the overlap region is less than the threshold th6 is included in the Gerber data as the object to be processed is performed. Since the threshold th6 is set according to the resolution of the drawing in the above-described step 102, it can be checked whether the pattern having an overlap region with an insufficient width, which causes the problem of the printed wiring board, is included in the wiring pattern, with high precision. When the check process of the step 166 is completed, the process progresses to a step 168, in which it is determined whether the corresponding data is detected in the check process of the step 166. If the determination is “no”, the process progresses to a step 172 and, if the determination is “yes”, the process progresses to a step 170, which stores the error type information indicating that the detected error (defect) is an error that the data defining the pattern in which the width of the overlap region is insufficient is included in the Gerber data as the object to be processed, and coordinate information indicating the position of the pattern, in which the width of the overlap region is insufficient, on the wiring pattern represented by the Gerber data in the memory, and then progresses to the step 172.

For example, as shown in FIG. 5B, if a pattern in which a gap GAP between adjacent patterns is insufficient is included in the wiring pattern, a possibility that this pattern causes a problem in the printed wiring board fabricated by the drawing process using the exposure device 12 is high. Accordingly, in the step 172, a process of checking whether or not data defining a pattern in which the gap GAP between the adjacent patterns is less than the threshold th7 is included in the Gerber data as the object to be processed is performed. Since the threshold th7 is set according to the resolution of the drawing and the type of the photosensitive material coated on the board in the above-described step 104, it can be checked whether the pattern having an insufficient the gap, which causes the problem of the printed wiring board, is included in the wiring pattern, with high precision. When the check process of the step 172 is completed, the process progresses to a step 174, in which it is determined whether the corresponding data is detected in the check process of the step 172. If the determination is “no”, the process progresses to a step 178 and, if the determination is “yes”, the process progresses to a step 176, which stores the error type information indicating that the detected error (defect) is an error that the data defining the pattern in which the gap is insufficient is included in the Gerber data as the object to be processed, and coordinate information indicating the position of the pattern, in which the gap is insufficient, on the wiring pattern represented by the Gerber data in the memory, and then progresses to the step 178.

In the step 178, it is determined whether any error (defect) is detected in the Gerber data as the object to be processed by the above-mentioned check processes, on the basis of whether or not error information such as the error type information is stored in the memory. If the determination is “no” (if no error is detected), the process progresses to a step 180, which stores the Gerber data as the object to be processed in the checked Gerber data folder 46, and then the data check process is completed.

Meanwhile, if the determination in the step 178 is “yes” (if at least one error is detected), the process progresses to a step 182, which loads the error information stored in the memory and determines whether the coordinate information is included in the loaded error information. If the coordinate information is included in the error information, that is, if an error which can designate the error position is detected on the wiring pattern represented by the Gerber data as the object to be processed, a Gerber error file for designating the error position on the wiring pattern represented by the Gerber data as the object to be processed is generated on the basis of the loaded error information (error type information and the coordinate information) and the generated Gerber error file is added to the Gerber data as the object to be processed. The step 182 corresponds to data generation means according to the present invention and the data check processing portion 28 for performing the process of the step 182 also corresponds to the data generation means according to the present invention.

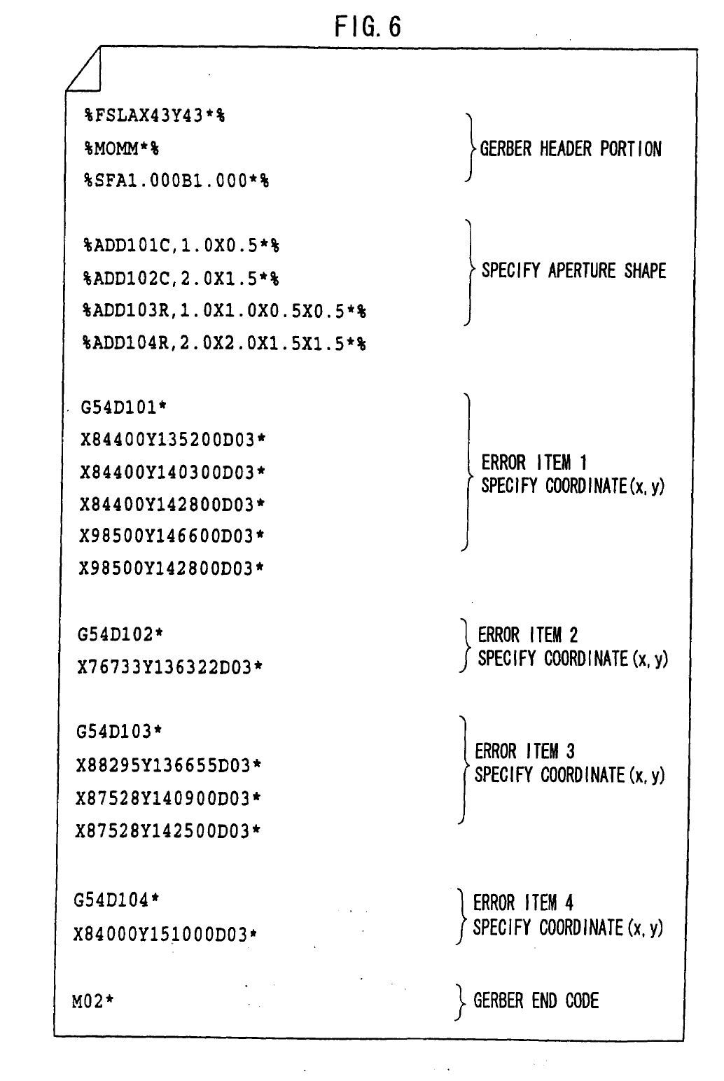

The Gerber error file according to the present embodiment is data which can be handled as the Gerber data. For example, as shown in FIG. 6, the Gerber data file is structured such that, between a Gerber header portion and a Gerber end code, mark data (“specifying aperture shape” described in FIG. 6) defining the shape or the size of a predetermined mark (aperture) which is to be designated at the error position (position represented by the coordinate information included in the loaded error information) and coordinate data (“error item n” and “specifying coordinate (x, y)” described in FIG. 6) defining the designation position of the predetermined mark on the wiring pattern are described. In the step 182, the above-mentioned coordinate data is set on the basis of the coordinate information included in the loaded error information and the marks corresponding to the respective error types are designated at the respective error positions defined by the coordinate data, such that the Gerber error file is generated.

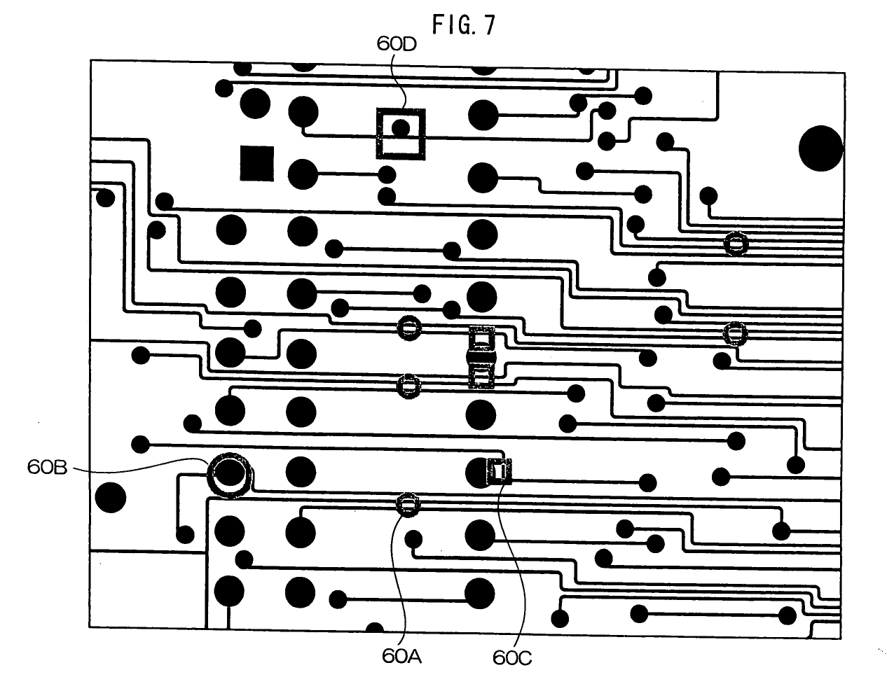

In the step 184, a predetermined message is displayed on the display via the job registration GUI 24 to notify that the error is detected in the Gerber data as the object to be processed, the contents of the detected error is displayed on the display via the job registration GUI 24, and then the data check process is completed. In the display of the contents of the error, a message for notifying the contents of the error is simply displayed on the display if the detected error is an error in which the error position is hard to be designated (the coordinate information is not stored at the time of detecting the error), such as an error in which the number of the layers configuring the Gerber data as the object to be processed exceeds the upper limit, and the contents of the error are designated by displaying an error position designating image, wherein the marks defined by the mark data at the error positions represented by the coordinate data of the Gerber error file in the wiring pattern represented by the Gerber data as the object to be processed are overlappingly displayed, as shown in FIG. 7, on the basis of the Gerber error file generated in the step 182, if the detected error is an error in which the error position can be designated (the coordinate information is stored at the time of detecting the error). At the time of displaying the contents of the error, a specific error position may be enlarged and displayed and the enlarged error position may be sequentially switched according to an instruction of the user.

In the error position designating image shown in FIG. 7, the marks corresponding to the error types at the respective error positions among the marks 60A to 60D which are different from each other in at least one of the size and the shape are displayed at the respective error positions on the wiring pattern. Accordingly, the user can easily recognize the error position on the wiring pattern represented by the Gerber data and the error type at the error positions. Since the Gerber error file has a format which can be handled as the Gerber data, the Gerber data as the object to be processed, to which the Gerber error file is added, may be transmitted to the computer 18 functioning as the CAM system and the error position designating image shown in FIG. 7 may be displayed on the display of the computer 18. Accordingly, it is possible to easily perform an operation for correcting the Gerber data on the CAM system on the basis of the error detected by the error check process.

Accordingly, by performing the above-described data check process, it is possible to prevent a problem from occurring in the printed wiring board fabricated by the drawing process using the exposure device 12 due to the Gerber data and to detect the defect of the Gerber data, which causes the problem, before performing the RIP process. Thus, the process such as the RIP processing or the drawing using the exposure device 12 does not need to be repeatedly performed, and thus the progress of the operation such as the fabrication of the board can be prevented from being affected by the defect of the Gerber data or the board can be prevented from being consumed in vain due to the defect.

Meanwhile, in the screen which can be displayed on the display of the image processing device 14 by the layout checking GUI 30, a layout check instructing screen for instructing the check of the layout of the wiring pattern represented by the Gerber data (Gerber data after the data check process) stored in the checked Gerber data folder 46 is included. Although not shown, in the layout check instructing screen, a display section for displaying a list of file names of the Gerber data stored in the checked Gerber data folder 46 and a button for instructing the execution of the layout checking process with respect to the Gerber data selected from the Gerber data listed and displayed in the display section as an object to be processed are provided.

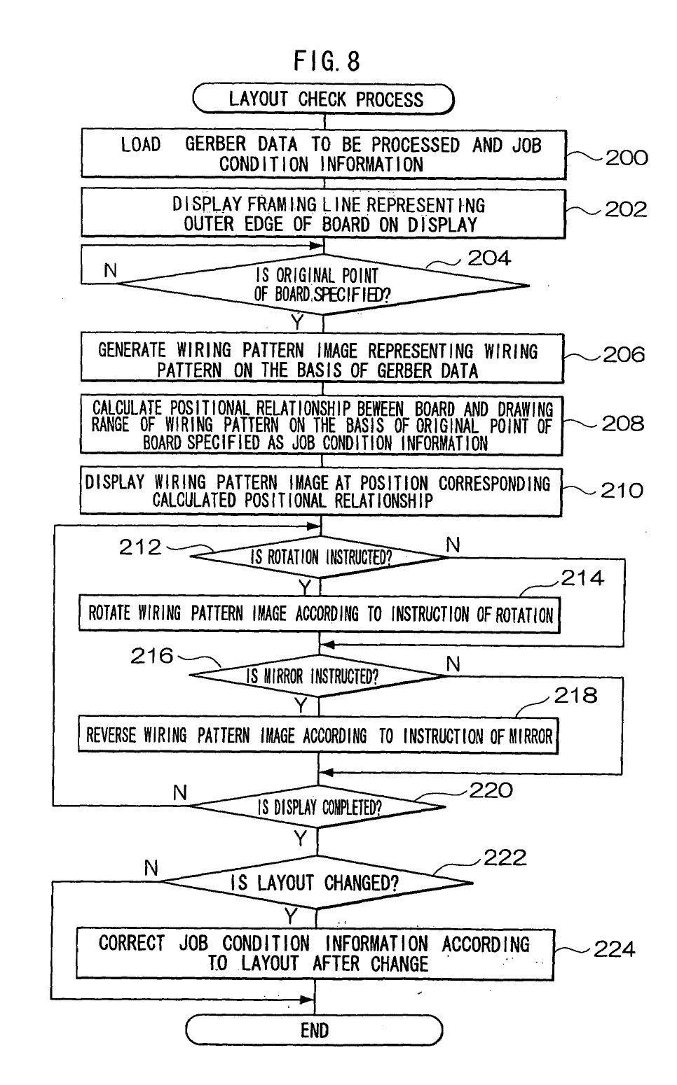

With respect to the wiring pattern represented by the Gerber data after the data check process, if the layout (the position of the drawing range of the wiring pattern with respect to the board or the angle of the wiring pattern in the horizontal surface, or the front or rear orientation) is desired to be checked, the user manipulates the keyboard or the mouse to instruct the display of the layout check instructing screen on the display with respect to the layout check GUI 30, selects the Gerber data as the object to be processed from the Gerber data listed and displayed in the display section in a state in which the layout check instructing screen is displayed on the display, and selects the button in the layout check instructing screen to instruct the execution of the layout check process for the Gerber data as the object to be processed. This instruction is input to the layout display processing portion 32 via the layout check GUI 30 and the layout check process shown in FIG. 8 is performed by the layout display processing portion 32.

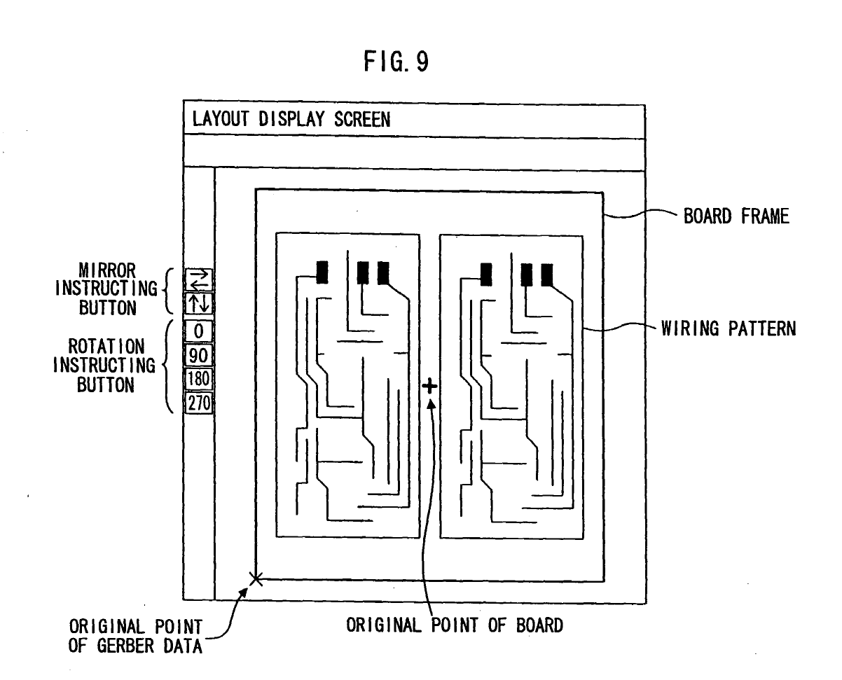

In the layout check process, first, in a step 200, the specified Gerber data as the object to be processed is loaded from the checked Gerber data folder 46 and the job condition information corresponding to the Gerber data as the object to be processed is loaded from the job condition information folder 48. In a step 202, the layout check screen (see FIG. 9) for displaying an image for checking the layout of the wiring pattern represented by the Gerber data as the object to be processed is displayed on the display by the layout check GUI 30 and a framing line (“board frame” described in FIG. 9) indicating the outer edge of the board is displayed in an image display region of the layout check screen on the basis of information such as the size of the board included in the job condition information loaded in the step 200.

In a step 204, a message for requesting the specification of the position of the original point on the board to the user is displayed on the display and it is determined whether the position of the original point on the board is specified on by the user. The step 204 is repeated until the determination becomes “yes”. When the user specifies the position of the original point on the board (generally, the central position of the board) according to the message displayed on the display, the determination of the step 204 becomes “yes” and the process progresses to a step 206, which generates a wiring pattern image in which the wiring pattern represented by the Gerber data as the object to be processed is reduced and displayed according to the size of the framing line displayed in the image display region of the layout check screen, on the basis of the Gerber data as the object to be processed which is loaded in the step 200.

In a step 208, the position of the drawing range, the rotation angle, and the presence/absence and the direction of the reverse of the wiring pattern relative to the original point on the board when the wiring pattern represented by the Gerber data as the object to be processed is drawn on the board according to the current job condition information are calculated, on the basis of a positional relationship between the original point of the Gerber data included in the Gerber data as the object to be processed and the original point on the board, the presence/absence of the rotation or the reverse (mirror), the direction of the rotation angle and the reverse (mirror) of the wiring pattern represented by the Gerber data which are included in the job condition information corresponding to the Gerber data as the object to be processed, and the position of the original point on the board specified by the user. The steps 200 and 208 are the processes corresponding to calculation means according to the present invention and the layout display processing portion 32 for performing the processes of the steps 200 and 208 corresponds to the calculation means according to the present invention.

In a step 210, the wiring pattern image generated in the step 206 is rotated in the horizontal surface or is reversed in the front or rear orientation as necessary on the basis of the calculated result of the step 208 and is then displayed at the position calculated in the step 208 in the image display region of the layout check screen (the state shown in FIG. 9). The step 210 is the process corresponding to positional relationship display control means according to the present invention and the layout display processing portion 32 for performing the process of the step 210 corresponds to the positional relationship display control means according to the present invention.

As shown in FIG. 9, in the layout check screen, a rotation instructing button for instructing the rotation of the wiring pattern and a mirror instructing button for instructing the reverse (mirror) of the wiring pattern are provided. In a next step 212, it is determined whether the rotation of the wiring pattern is instructed depending on whether the rotation instructing button in the layout check screen is selected. If the determination is “no”, the process progresses to a step 216, which determines whether the mirror (reverse) of the wiring pattern is instructed depending on whether the mirror instructing button in the layout check screen is selected. If this determination is “no”, the process progresses to a step 220, which determines whether the completion of the display of the layout check screen is instructed. If this determination is “no”, the process returns to the step 212 and the steps 212, 216 and 220 are repeated until any one of the steps 212, 216 and 220 becomes “yes”.

When the wiring pattern image is displayed in the image display region of the layout check screen, the user checks whether the position of the displayed wiring pattern image relative to the board, the angle of the wiring pattern image in the horizontal surface and the front or rear orientation of the wiring pattern image are proper with respect to the framing line representing the outer edge of the board. Here, if it is determined that the position of the wiring pattern image is not proper with respect to the board, the user completes the display of the layout check screen and then corrects the data defining the positional relationship between the original point of the Gerber data included in the Gerber data as the object to be processed and the original point on the board such that the position of the drawing range of the wiring pattern relative to the original point on the board when the wiring pattern represented by the Gerber data as the object to be processed is drawn on the board is corrected.

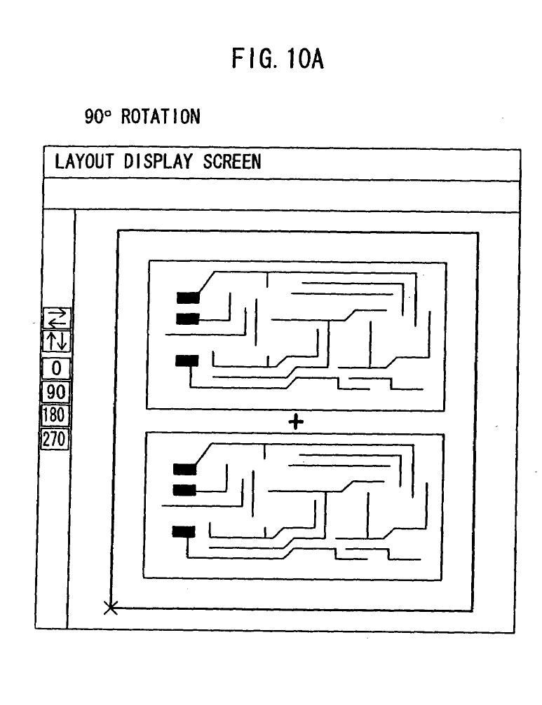

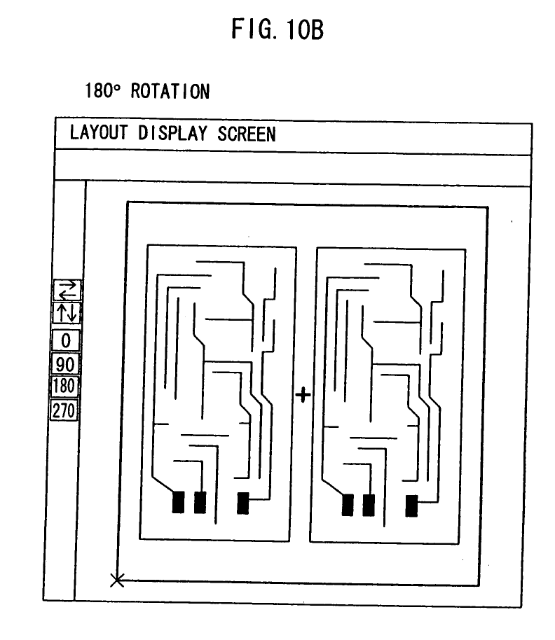

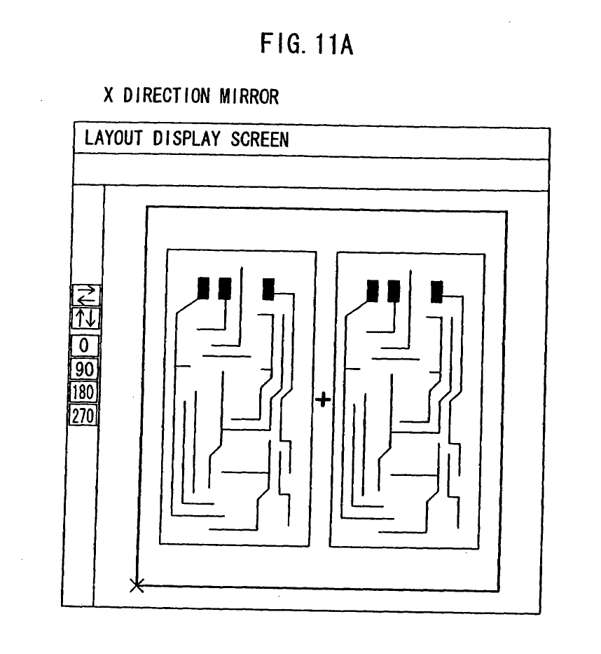

If it is determined that the angle of the wiring pattern image in the horizontal surface is not proper, the user selects the rotation instructing button to instruct the rotation of the wiring pattern. In the layout check screen, a plurality of buttons for rotating the wiring pattern by different rotation angles (for example, 90°, 180°, 270°) are provided as the rotation instructing button and a rotation instructing button corresponding to a desired rotation angle is selected. When the rotation instructing button is selected, the determination of the step 212 becomes “yes” and the process progresses to a step 214, which rotates the wiring pattern image displayed in the image display region of the layout check screen by the rotation angle corresponding to the selected rotation instructing button, and then progresses to a step 216. For example, if the 90° rotation of the wiring pattern image shown in FIG. 9 is instructed, the wiring pattern image is rotated as shown in FIG. 10A and, if the 180° rotation of the wiring pattern image shown in FIG. 9 is instructed, the wiring pattern image is rotated as shown in FIG. 10B.

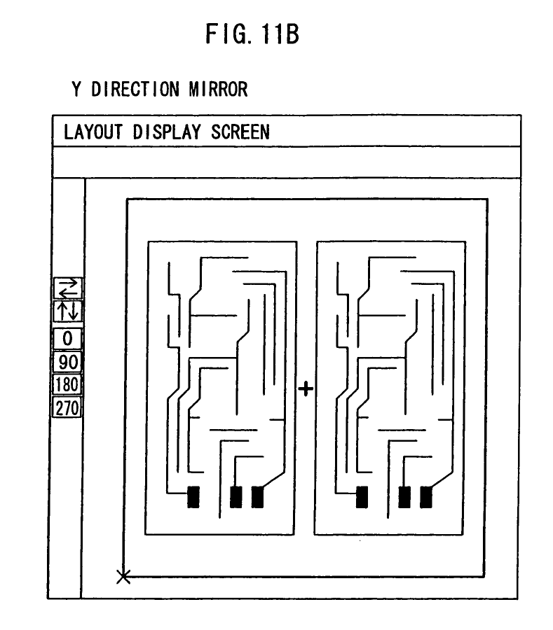

If it is determined that the front or rear orientation of the wiring pattern image is not proper, the user selects the mirror instructing button to instruct the reverse (mirror) of the front or rear orientation of the wiring pattern. In the layout check screen, as a mirror instructing button, a plurality of buttons for reversing the wiring pattern in different directions (for example, an X direction and a y direction) are provided and a mirror instructing button corresponding to a desired reverse direction is selected. When the mirror instructing button is selected, the determination of the step 216 becomes “yes” and the process progresses to a step 218, which reverses the front or rear orientation of the wiring pattern image displayed in the image display region of the layout check screen in the reverse direction corresponding to the selected mirror instructing button, and then progresses to a step 220. For example, if the reverse of the front or rear orientation of the wiring pattern image shown in FIG. 9 is instructed in the x direction, the front or rear orientation of the wiring pattern image is reversed as shown in FIG. 11A and, if the reverse of the front or rear orientation of the wiring pattern image shown in FIG. 9 is instructed in the y direction, the front or rear orientation of the wiring pattern image is reversed as shown in FIG. 11B.

When the completion of the display of the layout check screen is instructed, the determination of the step 220 becomes “yes” and the process progresses to a step 222, which determines whether the change of the layout of the wiring pattern (rotation in the horizontal surface or the reverse of the front or rear orientation) in the above-described process is instructed. If the determination is “no”, the layout check process is completed without performing any process and, if the determination of the step 222 is “yes”, the process progresses to a step 224, which corrects corresponding data of the data such as the presence/absence of the rotation or the reverse of the wiring pattern included in the job condition information of the Gerber data as the object to be processed or the direction of the rotation angle and the reverse of the wiring pattern according to the rotation of the wiring pattern in the horizontal surface or the reverse of the front or rear orientation of the wiring pattern and overwrites the corrected job condition information in the job condition information folder 48, and the layout check process is completed.

Since, by the above-described layout check process, before the wiring pattern is actually drawn on the board, it can be determined whether the layout of the wiring pattern (the position of the drawing range of the wiring pattern relative to the board, the angle of the wiring pattern in the horizontal plane, and the front or rear orientation) when the wiring pattern represented by the Gerber data as the object to be processed is drawn on the board according to the current job condition information, therefore it is possible to prevent the board from being consumed in vain.

In the screen which can be displayed on the display of the image processing device 14 by the raster display GUI 34, a raster display instructing screen for instructing the expansion of a portion of specific Gerber data stored in the checked Gerber data folder 46 to raster data and the display of the raster data on the display is included. Although not shown, in the raster display instructing screen, a display section for displaying a list of file names of Gerber data stored in the checked Gerber data folder 46 and a button for instructing the execution of the raster display of Gerber data selected from the Gerber data listed and displayed in the display section as an object to be processed are provided.

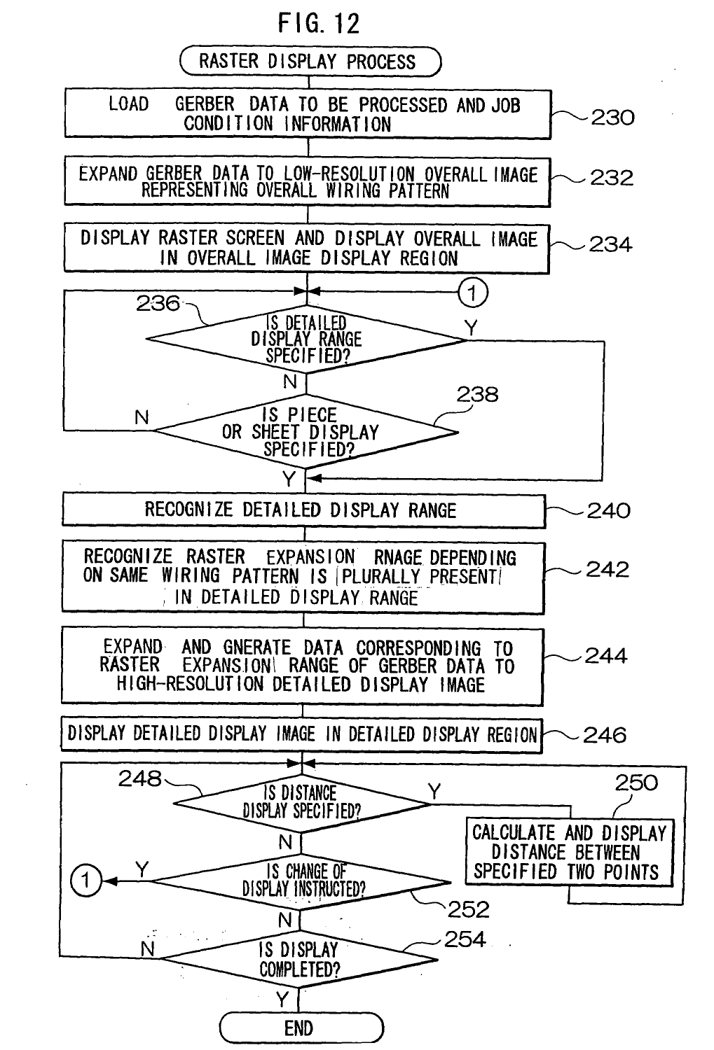

When the visible check is desired to be performed with respect to the wiring pattern represented by the Gerber data stored in the checked Gerber data folder 46, the user manipulates the keyboard or the mouse to instruct the display of the raster display instructing screen on the display to the raster display GUI 34, selects the Gerber data as the object to be processed from the Gerber data listed and displayed in the display section in a state in which the raster display instructing screen is displayed on the display, and selects the button in the raster display instructing screen to instruct the execution of the raster display process to the Gerber data as the object to be processed. This instruction is input to the RIP processing portion 36 via the raster display GUI 34 and the raster display process shown in FIG. 12 is performed by the RIP processing portion 36.

In the raster display process, first, in a step 230, the specified Gerber data as the object to be processed is loaded from the checked Gerber data folder 46 and the job condition information corresponding to the Gerber data as the object to be processed is loaded from the job condition information folder 48. In a step 232, the overall Gerber data as the object to be processed is expanded to the raster data (overall image) of low resolution. The expansion from the Gerber data to the raster data can be, for example, performed by ensuring a drawing region having a size according to the resolution of the raster data for output on the memory and repeatedly drawing a line or the like in the drawing region while sequentially referring to the Gerber data from the lead. Accordingly, it is possible to obtain the overall image representing the overall wiring pattern represented by the Gerber data as the object to be processed in low resolution.

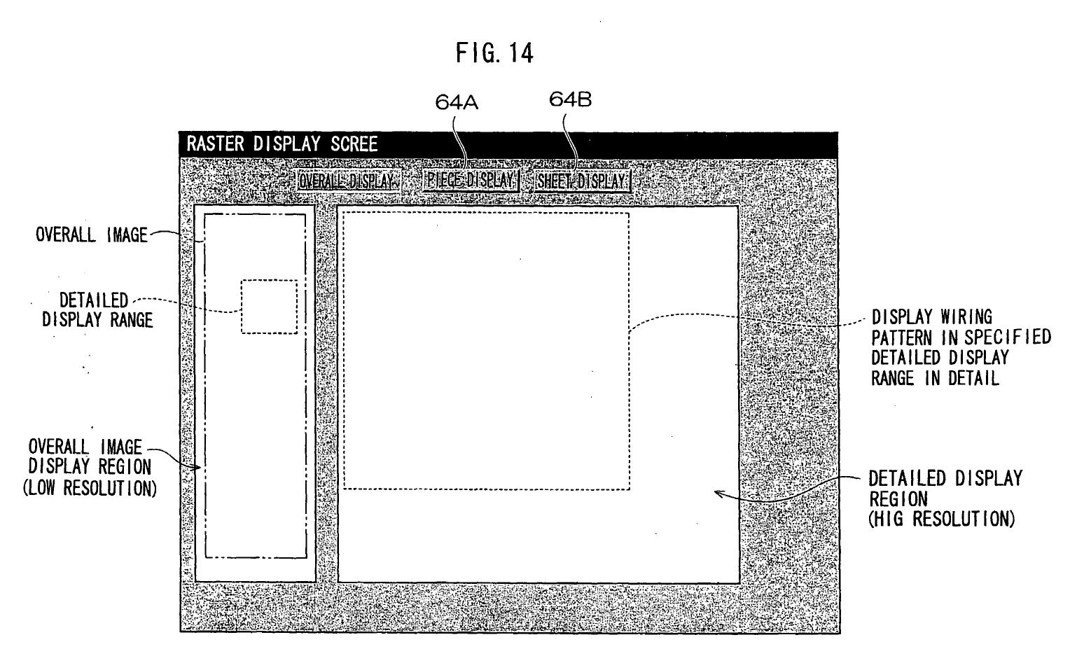

In a next step 234, the raster display screen (see FIG. 14) for displaying the raster image of the wiring pattern represented by the Gerber data as the object to be processed is displayed on the display by the raster display GUI 34. In addition, as shown in FIG. 14, in the raster display screen, an overall image display region for displaying the overall image of low resolution and a detailed display region for displaying a higher-resolution detailed display image representing the wiring pattern are provided. The overall image obtained by the process of the step 232 is displayed on the overall image display region of the raster display screen by the raster display GUI 34. The steps 232 and 234 are the processes corresponding to low-resolution image display control means according to the present invention and the RIP processing portion 36 for performing the steps 232 and 234 corresponds to low-resolution image display control means according to the present invention.

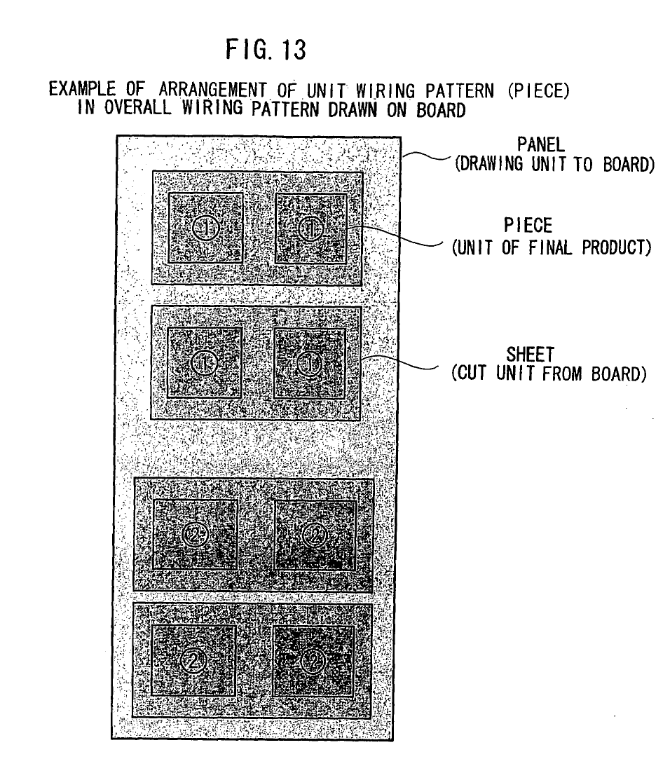

Although a drawing unit of the wiring pattern on the board (overall wiring pattern which is drawn on the board by the exposure device 12 by one drawing process) is called a panel (or a work), if the printed wiring board as a final product is a printed wiring board which is mounted in a small apparatus such as a mobile telephone or a personal digital assistant (PDA), the size thereof is significantly smaller than that of the panel and thus, for example, as shown in FIG. 13, a “piece” which is the unit of the final product may be plurally arranged in the panel. If the size of the piece is small, the board is cut to panels in the unit of a sheet in which the pieces representing the same wiring pattern are plurally arranged, circuit elements are mounted in the pieces of the cut panel, and the panel is cut to portions. In the raster display process according to the present embodiment, as a method of specifying a range for displaying the detailed display image in the detail display region, in addition to a method of specifying a detailed display range on the overall image displayed in the overall image display region, a method of specifying a desired piece or panel on the overall image as a detailed display object is provided. As shown in FIG. 14, in the raster display screen, a button 64A for instructing the detailed display in the piece unit and a button 64B for instructing the detailed display in the sheet unit are provided.

In a next step 236, it is determined whether the detailed display range to be displayed as the detailed display image is specified in the detailed display region, by drawing a frame (see FIG. 14) representing the detailed display range on the overall image displayed in the overall image display region. If the determination of the step 236 is “no”, the process progresses to a step 238, which determines whether a specific piece in the overall image is selected and the detailed display of the piece unit is specified by selecting the button 64A, or whether a specific sheet in the overall image is selected and the detailed display of the sheet unit is specified by selecting the button 64B. If the determination of the step 238 is also “no”, the process returns to the step 236 and then the steps 236 and 238 are repeated until the determination of the step 236 or the step 238 becomes “yes”.

When the operation for instructing the detailed display by any one of the above-described specifying methods is performed by the user, the determination of the step 236 or the step 238 becomes “yes” and then the process progresses to a step 240, which allows the user to recognize the specified detailed display range. That is, the inside of the drawn frame is recognized as the detailed display range in a case where the frame representing the detailed display range is drawn on the overall image, an overall specific piece selected on the overall image is recognized as the detailed display range if the detailed display of the piece unit is instructed, and an overall specific sheet selected on the overall image is recognized as the detailed display range if the detailed display of the sheet unit is instructed.

In a next step 242, it is determined whether the same wiring pattern (the piece representing the same wiring pattern) is plurally included in the detailed display range recognized in the step 240, and a range for expanding the Gerber data to the raster data is set in the detailed display range on the basis of the determined result. For example, if the detailed display of the piece unit is instructed, since the same wiring pattern is not plurally included in the detailed display range, the detailed display range recognized in the step 240 is set to be the raster expansion range. In contrast, if the detailed display of the sheet unit is instructed or if the detailed display of the range drawn on the overall image is instructed, a plurality of pieces representing the same wiring pattern may be included in the detailed display range. If the plurality of pieces representing the same wiring pattern are not included in the detailed display range, the detailed display range is set to be the raster expansion range, but if the plurality of pieces representing the same wiring pattern are included in the detailed display range, the range excluding the pieces other than any one piece is set to be the raster expansion range.

In a next step 244, Gerber data corresponding to the raster expansion range is extracted from the Gerber data as the object to be processed and the extracted Gerber data is expanded to the high-resolution raster data. The resolution of the raster data is preferably equal to the resolution of the drawing in consideration of the below-described calculation and the display of the distance, but the resolution may be adjusted such that the overall detailed display image representing the wiring pattern in the detailed display range falls into the detailed display region of the raster display screen. If the raster expansion range set in the step 242 is equal to the detailed display range recognized in the step 240, the raster data correspond with the detailed display image representing the wiring pattern in the detailed display range. However, since the plurality of pieces representing the same wiring pattern are included in the detailed display range, if a portion of the detailed display range is set to be the raster expansion range, the detailed display image representing the wiring pattern in the detailed display range is generated by adding framing line data representing the outer edge of the pieces excluded from the raster expansion range to the raster data. In a next step 246, the detailed display image obtained by the process of the step 244 is displayed in the detailed display region of the raster display screen by the raster display GUI 34.

The steps 242 and 244 are processes corresponding to expansion means according to the present invention, the step 246 is a process corresponding to high-resolution image display control means according to the present invention, and the RIP processing portion 36 performing the processes of the steps 242 to 246 corresponds to the expansion means and the high-resolution image display control means according to the present invention.

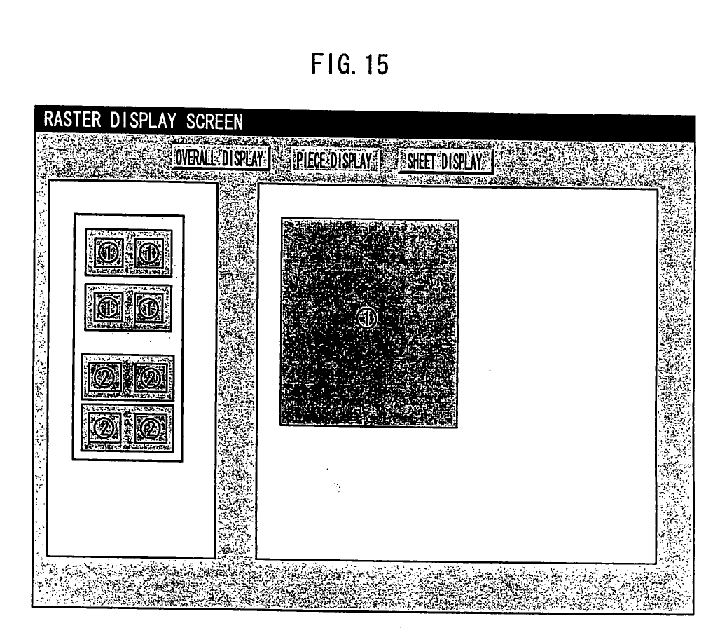

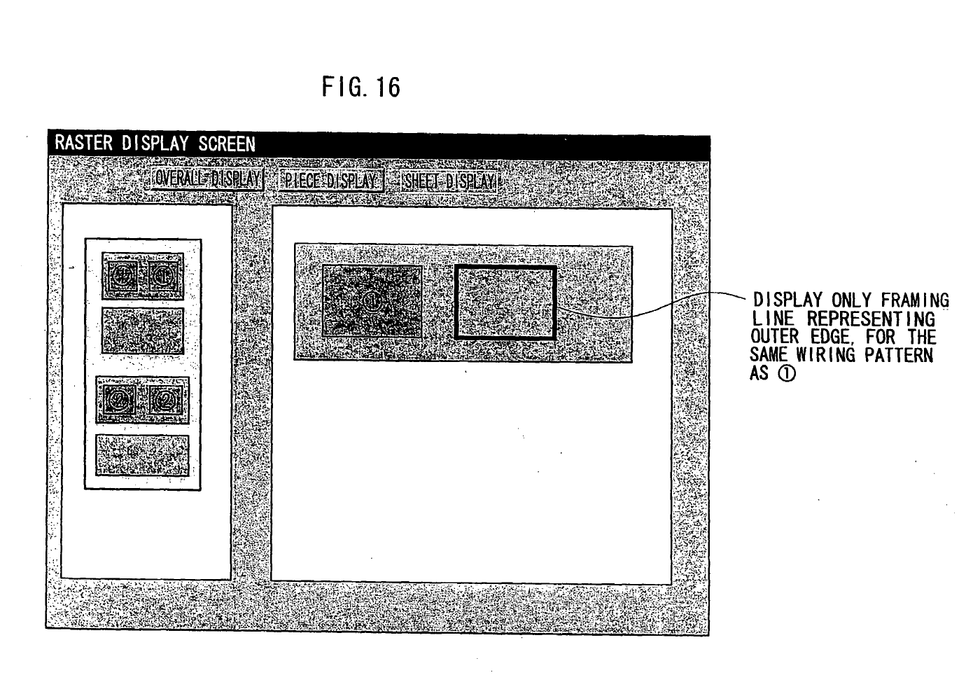

Accordingly, if the detailed display of the piece unit is instructed, for example, as shown in FIG. 15, only the wiring pattern of a single piece selected as a detailed display object is displayed in detail in the detailed display region of the raster display screen. If the detailed display of the sheet unit is instructed, for example, as shown in FIG. 16, only the wiring pattern of a single sheet selected as the detailed display object is displayed in detail in the detailed display region of the raster display screen. However, if the pieces representing the same wiring pattern are plurally arranged in the selected sheet, as shown in FIG. 16, the wiring pattern is displayed in detail in only one of the plurality of pieces and only the framing lines representing the outer edges of the remaining pieces are displayed.

In the raster display process, the high-resolution raster data are generated and displayed with respect to only a portion displayed in the detailed display region of the raster display screen in the wiring pattern represented by the Gerber data as the object to be processed, therefore after the overall Gerber data as the object to be processed is expanded to the drawing raster data by the RIP processing, the raster display of the wiring pattern can be performed at a high speed, when compared with the case where the wiring pattern is raster-displayed using the drawing raster data. Even when a problem is found by the visible check with respect to the raster-displayed wiring pattern, the RIP processing which is time-consuming does not need to be performed several times.

In a case where the panel (overall wiring pattern) in which a plurality of pieces representing the same wiring pattern are arranged is drawn, the Gerber data defines the overall wiring pattern by data defining the wiring pattern with respect to only a single piece and data for instructing the copy of the wiring pattern represented by the data to the positions corresponding to the respective pieces, therefore the visible check does not need to be performed with respect to all the plurality of pieces arranged in the panel even at the time of the visible check of the wiring pattern represented by the Gerber data and the visible check is performed with respect to only any one of the plurality of pieces representing the same wiring pattern. Accordingly, when the plurality of pieces representing the same wiring pattern are included in the detailed display range, there is no difficulty in the visible check even when the wiring pattern is displayed in detail with respect to only the single piece as described above. Accordingly, by performing the process of expanding only the single piece to the high-resolution raster data, it is possible to perform the display of the detailed display image in the detailed display region of the raster display screen in a short time.

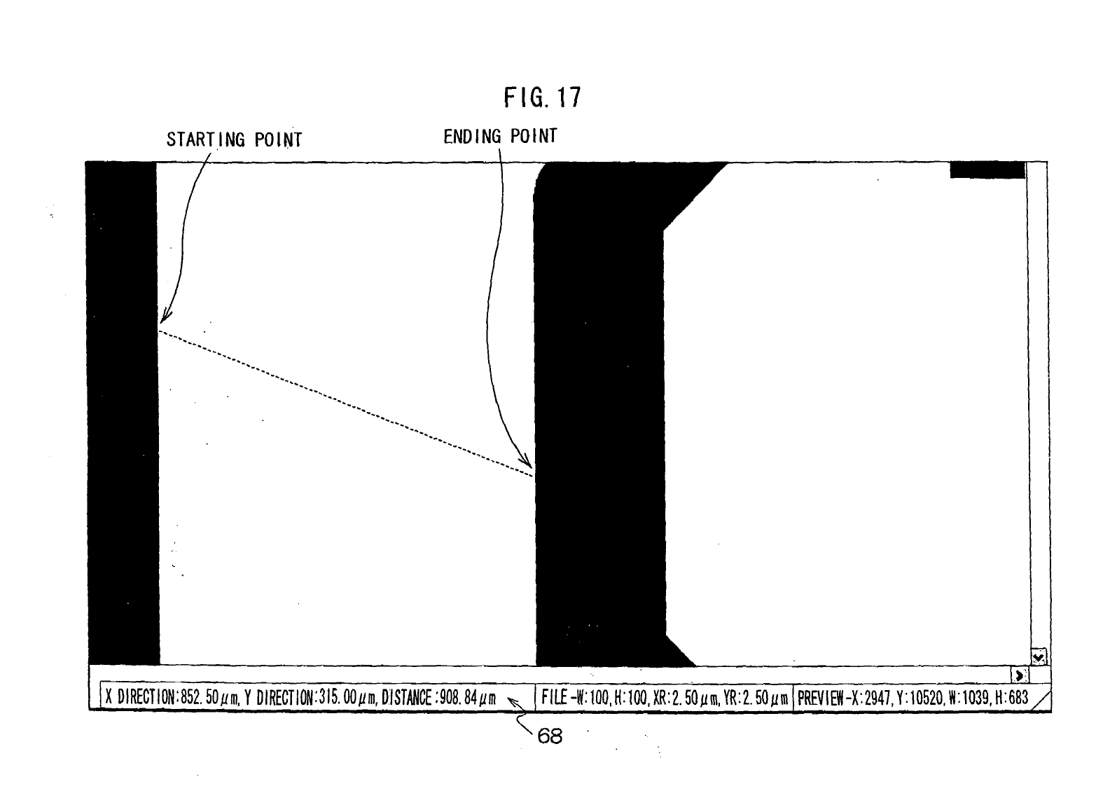

In a case where the resolution of the raster data is equal to the resolution of the drawing, in the detailed display region of the raster display screen, for example, as shown in FIG. 17, the wiring pattern enlarged according to a ratio of a pixel interval on the board at the time of drawing process using the exposure device 12 to a pixel interval (interval between display dots) on the display is displayed. However, in the present embodiment, the distance between any two points specified on the displayed wiring pattern can be calculated and displayed in this state. The calculation and the display of the distance between the any two points can be instructed by performing a predetermined operation after specifying the positions of the desired two points (the starting point and the ending point described in FIG. 17) on the wiring pattern (in this manner, an auxiliary line for connecting the two points is displayed on the wiring pattern).

In a next step 248, it is determined whether the calculation and the display of the distance between the two points on the wiring pattern are instructed, by performing the above-described operation. If the determination of the step 248 is “no”, the process progresses to a step 252, which determines whether the switching of the display of the wiring pattern image displayed in the detailed display region in the raster display screen is instructed. If the determination of the step 252 is also “no”, the process progresses to a step 254, which determines whether the completion of the display of the raster display screen is instructed. If the determination of the step 254 is also “no”, the process returns to the step 248 and the steps 248, 252 and 254 are repeated until the determination of any one of the steps 248, 252 and 254 becomes “yes”.

Here, in a case where the calculation and the display of the distance between the any two points specified on the wiring pattern is instructed by performing the above-described operation, the determination of the step 248 becomes “yes” and the process progresses to a step 250, which calculates and displays the distance between the specified two points. Since the pixel interval on the board at the time of the drawing process using the exposure device 12 is previously known by the resolution of the drawing, the distance between the specified two points can be calculated by counting the X-direction pixel number and the Y-direction pixel number between the specified two points and multiplying the counted pixel numbers by the pixel interval on the board to so as obtain the X-direction distance and the Y-direction distance on the board between the specified two points and performing the calculation from the X-direction distance and the Y-direction distance. FIG. 17 shows a state in which the calculated result of the distance between the specified two points is displayed in the display section 68 together with the calculated X-direction distance and the Y-direction distance. The step 250 is a process corresponding to distance calculation and display means according to the present invention and the RIP processing portion 36 for performing the process of the step 250 corresponds to the distance calculation and display means according to the present invention.

In the digital drawing method, since the wiring pattern represented by the drawing raster data is drawn on the board with predetermined resolution, the position of the boundary between the exposure portion and the non-exposure portion in the wiring pattern represented by the drawing raster data changes with a distance between adjacent pixels in the resolution of the drawing as a maximum with respect to the wiring pattern represented by the Gerber data due to the influence of a rounding error and, along with this change, the position of the boundary between the exposure portion and the non-exposure portion in the wiring pattern which is actually drawn on the board changes. Accordingly, it is preferable that the size of the gap between the adjacent patterns is finally checked by performing the visible check with respect to the wiring pattern represented by the drawing raster data. In the raster display process according to the present embodiment, when the calculation and the display of the distance between the any two points specified on the wiring pattern (detailed display image) displayed in the detailed display region of the raster display screen are instructed, the distance between the specified two points (the distance reflecting the rounding error) is calculated and displayed. Accordingly, it is possible to accurately and easily check the size of the gap between the adjacent patterns and to reduce the burden of the user who performs the visible check.

If the switching of the display (the change of the detailed display range or the like) of the wiring pattern image displayed in the detailed display region of the raster display screen is instructed, the determination of the step 252 becomes “yes”, the process returns to the step 236, and the processes after the step 236 are repeated according to the instruction of the user. If the completion of the display of the raster display screen is instructed, the determination of the step 254 becomes “yes” and the raster display process is completed. In the visible check performed by the user while the raster display process is executed, if a problem such as an insufficient gap between the adjacent patterns or the like is detected in the wiring pattern, in the computer 18 functioning as the CAM system, the operation of correcting the Gerber data as the object to be processed so as to solve the detected problem is performed and the raster display process (visible check) is performed again.

If the problem of the wiring pattern is not detected in the visible check, the user instructs the execution of the RIP processing to the Gerber data as the object to be processed. Accordingly, the RIP processing portion 36 loads the Gerber data, which is subjected to the RIP processing, from the checked Gerber data folder 46, performs the RIP processing of expanding the loaded overall Gerber data as the object to be processed to the drawing raster data in high resolution, and stores the drawing raster data obtained by the RIP process in the drawing raster data folder 50. When the RIP processing is completed, the user instructs the drawing of the wiring pattern represented by the drawing raster data on the board. Accordingly, the exposure device control portion 40 reads corresponding job condition information from the job condition information folder 48 and outputs the job condition information to the exposure device 12, and sequentially reads drawing raster data from the drawing raster data folder 50 and outputs the drawing raster data to the exposure device 12. Thus, the wiring pattern represented by the drawing raster data is drawn on the board using the exposure device 12 according to the job condition information.

As a data check process, the checking process performed by the checking means according to the present invention is not limited to the check processes shown in FIG. 3 and other checking processes such as the check for the presence/absence of the line of which the thickness is less than the threshold, the check for the presence/absence of the data for instructing the magnification change of the overall wiring pattern or the like may be applied without departing from the scope of the present invention.

Although, in the present embodiment, the exposure device 12 is, for example, described as the drawing device connected with the image processing device according to the present invention, the drawing device which can be connected to the image processing device according to the present invention is not limited to this and a drawing device for drawing a wiring pattern on a board by adhering metal particles or a precursor of metal particles to the board using an inkjet type and liquid ejection type drawing head. As such a drawing device, there are drawing devices described in Japanese Patent Application Laid-Open No. 2005-40665, Japanese Patent Application Laid-Open No. 2005-47073, Japanese Patent Application Laid-Open No. 2005-47085, Japanese Patent Application Laid-Open No. 2005-81710, Japanese Patent Application Laid-Open No. 2005-81711, Japanese Patent Application Laid-Open No. 2005-81716, Japanese Patent Application Laid-Open No. 2005-96332, Japanese Patent Application Laid-Open No. 2005-96338 and Japanese Patent Application Laid-Open No. 2005-96345.

### DESCRIPTION OF REFERENCE NUMERALS

10: board drawing system
12: exposure device
14: image processing device
18: computer
24: job registration GUI
28: data check processing portion
30: layout checking GUI
32: layout display processing portion
34: raster display GUI
36: RIP processing portion

1. An image processing device which is connected with a drawing device that directly draws on a board a wiring pattern represented by drawing raster data, and which performs RIP processing that expands image data in vector form representing the input wiring pattern to the drawing raster data, the apparatus comprising:
a checking means which checks whether a defect which causes a problem in the board fabricated by a drawing process using the drawing device is present in the image data, before performing the RIP processing with respect to the input image data.

2. The image processing device according to claim 1, wherein the checking means checks whether the defect is present in the image data, by acquiring a drawing condition applied when the drawing device draws the wiring pattern on the board, setting a threshold which is to be used for determination of the defect in the checking according to the acquired drawing condition, and performing the check using the set threshold.

3. The image processing device according to claim 2, wherein the drawing condition is a resolution applied when the wiring pattern is drawn or the type of a photosensitive material provided on the board.

4. The image processing device according to claim 2, wherein the checking means performs, as a process of checking whether or not the defect which causes the problem in the fabricated board is present, at least one of processes of: checking whether or not an arc portion having a circumference length of less than a first threshold is included in the wiring pattern represented by the image data, whether or not an arc portion having a radius difference between a starting point position and an ending point position equal to or greater than a second threshold is included in the wiring pattern, whether or not an arc portion having a radius equal to or greater than a third threshold is included in the wiring pattern, whether or not the wiring pattern is present at a coordinate separated from an original point by a distance equal to or greater than a fourth threshold, whether or not a pin-hole region having an area less than a fifth threshold is present in the wiring pattern represented by the image data, whether or not a pattern in which the width of a region overlapping with an adjacent pattern is less than a sixth threshold is present in the wiring pattern, or whether or not a pattern in which a gap between adjacent patterns is less than a seventh threshold is present in the wiring pattern.

5. The image processing device according to claim 3, wherein the checking means performs, as a process of checking whether or not the defect which causes the problem in the fabricated board is present, at least one of processes of: checking whether or not an arc portion having a circumference length of less than a first threshold is included in the wiring pattern represented by the image data, whether or not an arc portion having a radius difference between a starting point position and an ending point position equal to or greater than a second threshold is included in the wiring pattern, whether or not an arc portion having a radius equal to or greater than a third threshold is included in the wiring pattern, whether or not the wiring pattern is present at a coordinate separated from an original point by a distance equal to or greater than a fourth threshold, whether or not a pin-hole region having an area less than a fifth threshold is present in the wiring pattern represented by the image data, whether or not a pattern in which the width of a region overlapping with an adjacent pattern is less than a sixth threshold is present in the wiring pattern, or whether or not a pattern in which a gap between adjacent patterns is less than a seventh threshold is present in the wiring pattern.

6. The image processing device according to claim 1, wherein the checking means performs at least one of processes of checking whether or not a line using an aperture shape other than a circle is included in the wiring pattern and checking whether or not a self crossing line, which forms a closed curve having a starting point and an ending point positioned at the same position and which crosses itself between the starting point and the ending point, is included in the wiring pattern.

7. The image processing device according to claim 1, wherein the checking means checks whether or not the defect which causes an error in the RIP processing is present in the image data.

8. The image processing device according to claim 7, wherein the checking means performs at least one of processes of: checking whether or not a character other than a character type which can be handled in the RIP processing is included in the image data, whether or not the number of peaks of the wiring pattern is equal to or greater than an eighth threshold, and whether or not the number of layers that form the image data is equal to or greater than a ninth threshold, as a process of checking whether or not the defect which causes the error in the RIP processing is present.

9. The image processing device according to claim 1, further comprising a data generation means which, if it is determined that the defect is present in the image data by the checking means, acquires a coordinate of the wiring pattern at a position where it is determined that the defect is present, and on the basis of the acquired coordinate, generates defect position designating data designating a predetermined mark at the position in the wiring pattern, the mark being overlappingly displayable on the wiring pattern represented by the image data.

10. The image processing device according to claim 1, further comprising:
a calculation means which acquires a drawing condition applied when the drawing device draws the wiring pattern on the board and, on the basis of the acquired drawing condition and the image data, calculates a drawing range of the wiring pattern on the board when the drawing device draws the wiring pattern represented by the image data under the current drawing condition; and
a positional relationship display control means which displays a positional relationship between the board and the drawing range of the wiring pattern on the board on a display means when the drawing device draws the wiring pattern represented by the image data under the current drawing condition on the basis of the drawing range calculated by the calculation means.

11. The image processing device according to claim 1, further comprising:
a low-resolution image display control means which generates a low-resolution wiring pattern image representing the wiring pattern in low resolution and displays the generated low-resolution wiring pattern image on a display means, on the basis of the image data;
an expansion means which, when an enlarged display target region on the low-resolution wiring pattern image displayed on the display means by the low-resolution display control means, is specified via a specifying means, expands data corresponding to the enlarged display target region in the image data to high-resolution raster data and generates a high-resolution wiring pattern image representing the wiring pattern in the enlarged display target region in high resolution; and
a high-resolution image display control means which displays the high-resolution wiring pattern image generated by the expansion means on the display means.

12. The image processing device according to claim 11, wherein:
the wiring pattern drawn on the board by the drawing device is configured by arranging a plurality of sheets formed from plurally arranged identical unit wiring patterns that correspond to a single circuit pattern,
the low-resolution image display control means generates and displays an image representing the overall wiring pattern in low resolution as the low-resolution wiring pattern image, and
when a specific sheet is specified as the enlarged display target region on the low-resolution wiring pattern image representing the overall wiring pattern, the expansion means only expands data corresponding to a single specific unit wiring pattern in the specific sheet of the image data to high-resolution raster data, and generates an image as a high-resolution wiring pattern image of the specific sheet, wherein the wiring pattern is displayed with respect to only the specific unit wiring pattern, while only a framing line representing an outer edge is displayed with respect to other unit wiring patterns.

13. The image processing device according to claim 11, further comprising a distance calculation and display means which, when two points of a target for distance measuring are specified via the specifying means on the high-resolution wiring pattern image displayed on the display means by the high-resolution image display control means, calculates and displays on the display means a distance between the specified two points.

14. An image drawing apparatus comprising:
the image processing device according to claim 1,
wherein drawing on a drawing surface is performed on the basis of the drawing raster data obtained by the image processing device.

15. An image drawing system comprising:
at least one of a computer aided design (CAD) system or a computer aided Manufacturing (CAM) system which generates the image data in vector form;
the image processing device according to claim 1; and
a drawing device which performs drawing on a drawing surface on the basis of the drawing raster data obtained by the image processing device.

16. An image drawing apparatus comprising:
the image processing device according to claim 2, wherein drawing on a drawing surface is performed on the basis of the drawing raster data obtained by the image processing device.

17. An image drawing apparatus comprising:
the image processing device according to claim 3, wherein drawing on a drawing surface is performed on the basis of the drawing raster data obtained by the image processing device.

18. An image drawing apparatus comprising:
the image processing device according to claim 4, wherein drawing on a drawing surface is performed on the basis of the drawing raster data obtained by the image processing device.

19. An image drawing apparatus comprising:
the image processing device according to claim 5, wherein drawing on a drawing surface is performed on the basis of the drawing raster data obtained by the image processing device.

20. An image drawing apparatus comprising:
the image processing device according to claim 6, wherein drawing on a drawing surface is performed on the basis of the drawing raster data obtained by the image processing device.
